(19) United States
(12) Patent Application Publication
(10) Pub. No.: US 2006/0236253 A1
(43) Pub. Date: Oct. 19, 2006

(54) Dialog user interfaces for related tasks and programming interface for same

(75) Inventors: Paul A. Gusmorino, Seattle, WA (US); Judson Craig Hally, Sammamish, WA (US); Jan T. Miksovsky, Seattle, WA (US); Jeffrey S. Miller, Woodinville, WA (US); Vincent J. Pasceri, Redmond, WA (US); Richard S. Turner JR., Woodinville, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/106,724

(22) Filed: Apr. 15, 2005

(51) Int. Cl. G06F 3/00; G06F 17/30

(52) U.S. Cl. 715/762; 707/204

(57) ABSTRACT

One or more task page dialogs are housed within a frame. Each task page includes a header region and a content region. The header region includes a title serving as a main instruction regarding what input is expected within the content region. The content region includes text and/or user interface controls as defined by an application program requesting creation of the task page. A task page may also contain a footer region having button controls for a user to indicate that he or she has completed the task page and/or to terminate the task (or series of tasks) with which the page is associated. An application program requests creation of a task page by calling a programming interface function. Included in the function call are references to data for each of one or more pages.

### FIELD OF THE INVENTION

The invention generally relates to computer user interfaces (UIs) and to creation of user interfaces. More specifically, embodiments of this invention relate to dialog UIs and to programming interfaces allowing software developers to more conveniently create such dialogs.

### BACKGROUND OF THE INVENTION

The use of dialogs as part of a computer's graphical user interface (GUI) is known. As used herein, a “dialog” includes a window or other portion of a graphical computer display which appears in order to communicate information from a computer program and/or obtain information from the user. In some cases, a series of dialogs may be used to guide a user through a series of related tasks. A familiar example is the “wizard” concept used in various versions of the WINDOWS operating system (available from Microsoft Corporation of Redmond, Wash.). When installing a new application program on a computer, for example, an “installation wizard” is frequently employed. A first dialog of the wizard may inform a user that new software is about to be installed. That dialog may display a license agreement for the software in a scrolling text box and ask the user to agree to the terms of that license. The first dialog may include graphical buttons which the user can select to either accept the terms of the license (and proceed with installation) or reject the license (and thereby cancel the installation process). If the user selects the appropriate response in the first dialog (e.g., accepting the license), the first dialog disappears and a second dialog is displayed. The second dialog may ask the user for information needed for installing the program (e.g., the directory location for storing the program), after which third and subsequent dialogs may appear.

Whether implemented as a wizard or in some other manner, successive dialogs for related tasks can provide an efficient user interface. A well-designed series of such dialogs allows a user to quickly and efficiently understand what the computer is typing to do and what input is needed for each of the related tasks. In some cases, one of the dialogs in the series may be quite complicated and require multiple inputs. Returning to the program installation example from above, one of the dialogs may list a number of program components. That dialog may then give the user the option of selecting some components for full installation on the hard drive, selecting some components for partial installation (i.e., such that a CD must be inserted to use a partially installed component), or not installing some components at all. Even in such a circumstance, however, a well designed dialog will make it clear to the user what is needed and what the impact may be of the choices made.

Unfortunately, dialogs for a series of tasks are often poorly designed by software developers. In some cases, a user may be presented with a dialog having a large number of input options, but not given any guidance as to what the true objective may be. Consistency across multiple dialogs within the same series of dialogs is also an area of concern. If dialogs within the same series have a similar layout and appearance, a user can quickly learn where to look in each dialog to determine what is needed. If individual dialogs within a series have different layouts or are otherwise dissimilar in appearance, however, a user can become disoriented. Similar concerns exist with regard to dialogs that may be generated by different programs. In many environments, a single computer will often have software from numerous sources. One company may develop the operating system (OS), while other companies may develop individual application programs. The OS and other programs executing on the computer may all generate series of dialogs to guide a user through related tasks. If dialogs from all of these programs have a similar design, the user becomes accustomed to a general dialog format and learns where to look in each dialog for important information. If the dialogs have different layouts and are otherwise not consistent in how they communicate information and seek user input, the user may be required to spend more time studying each dialog.

In part to promote consistent dialog design, various guidelines have been promulgated. Unfortunately, software developers frequently fail to observe such guidelines. Developers may be unaware of or not fully understand the guidelines, or may simply be unwilling to follow them.

Many problems with dialog design are partly attributable to the existing tools available to software developers for creating a UI having a multiple dialogs. In particular, many existing systems require a software developer to create each individual dialog of a series from scratch. Maintaining consistency and good design practices across each individual dialog of the series can thus be time consuming and tedious. Even if a developer does create a consistent set of dialogs, however, those dialogs may not be consistent with those created by developers of other programs. For these and other reasons, there remains a need for methods and systems to assist software developers in creating better dialog user interfaces.

### SUMMARY OF THE INVENTION

Embodiments of the invention address these and other challenges. In at least some embodiments, one or more task page dialogs are created in response to a request from an application program. The task page dialogs are housed within a frame. Each task page includes a header region and a content region. The header region includes a title which can serve as a main instruction to the user regarding what input is expected within the content region. The content region includes text and/or user interface controls as defined by the application program requesting creation of the task page. A task page may also contain a footer region having button controls for a user to indicate that he or she has completed the task page (e.g., a “next” or “finish” button) and/or to terminate the task (or series of tasks) with which the page is associated.

In certain embodiments, an application program requests creation of a task page by calling a programming interface function. Included in the function call are data (or references to data) for each of one or more pages. As to each page, the data includes an indication of the main instruction for inclusion in the header region, as well as data indicative of the content for inclusion in the content region. In at least some embodiments, UI controls defined using pre-existing methods are packaged in the content region of a task page. A series of task pages are created using a collection of data structures corresponding to each of the pages in the series. Each of the page structures is in turn referenced by a sheet data structure. The sheet data structure is then referenced when accessing the programming interface to request generation of the task pages.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1A is a block diagram of an example of a computing system environment in which embodiments of the invention may be implemented.

FIGS. 1B through 1M show programming interfaces, in a general-purpose computer environment, with which one or more embodiments of the present invention may be implemented.

FIGS. 2A through 2H are examples of task page dialog user interfaces according to at least some embodiments of the invention.

FIGS. 3A through 3C are diagrams illustrating creation of task page dialogs according to at least some embodiments of the invention.

FIGS. 4A through 4C are examples of task page dialog user interfaces according to at least some additional embodiments of the invention.

### DETAILED DESCRIPTION OF THE PREFERRED EMBODIMENTS

The following detailed description is divided into three parts. Part I describes an example of a computer system environment in which embodiments of the invention may be implemented. Part II describes examples of at least some programming interfaces which can be used to implement embodiments of the invention. Part III describes embodiments of task page dialog user interfaces (UIs) and methods for implementing task page dialogs.

I. Example Computing System Environment

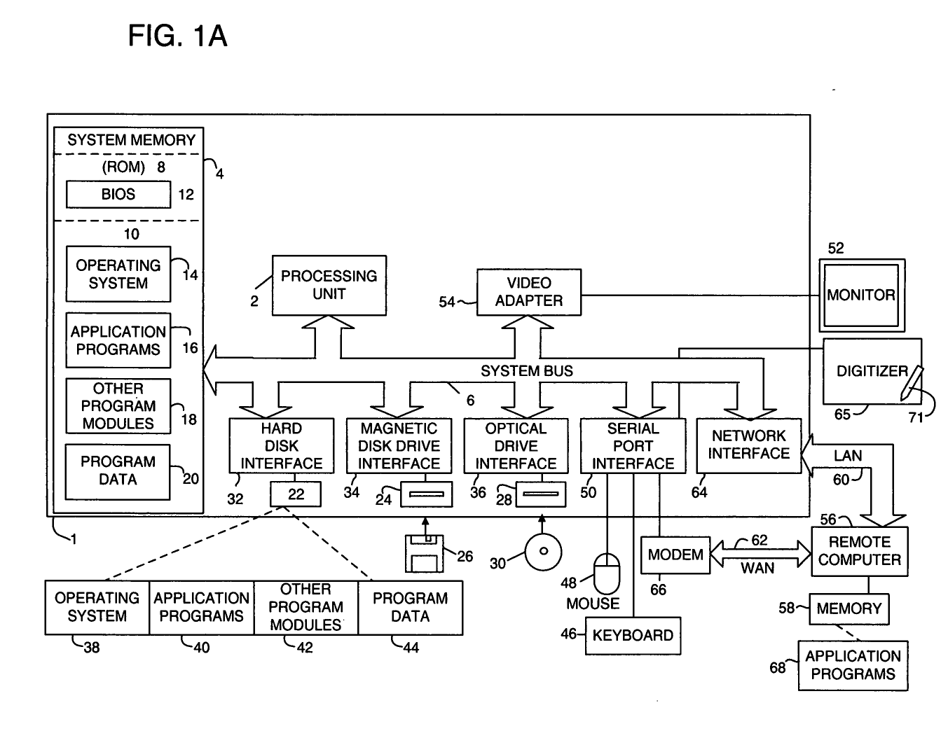

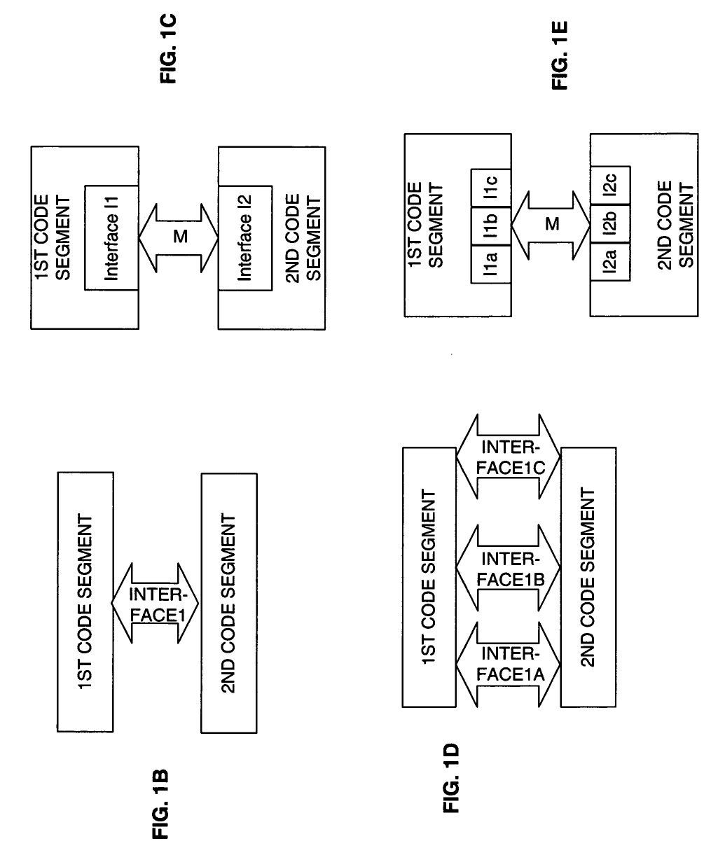

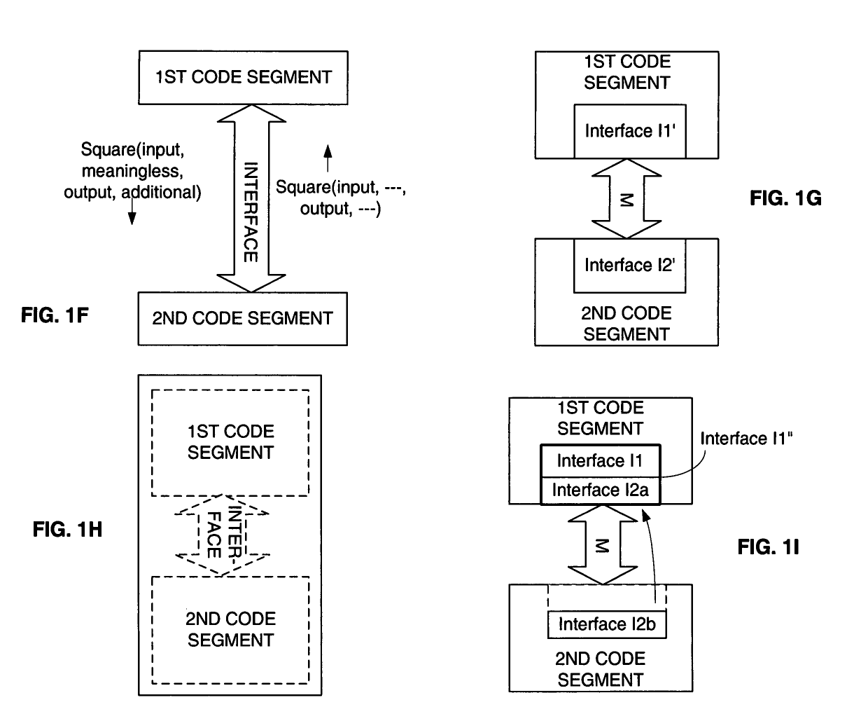

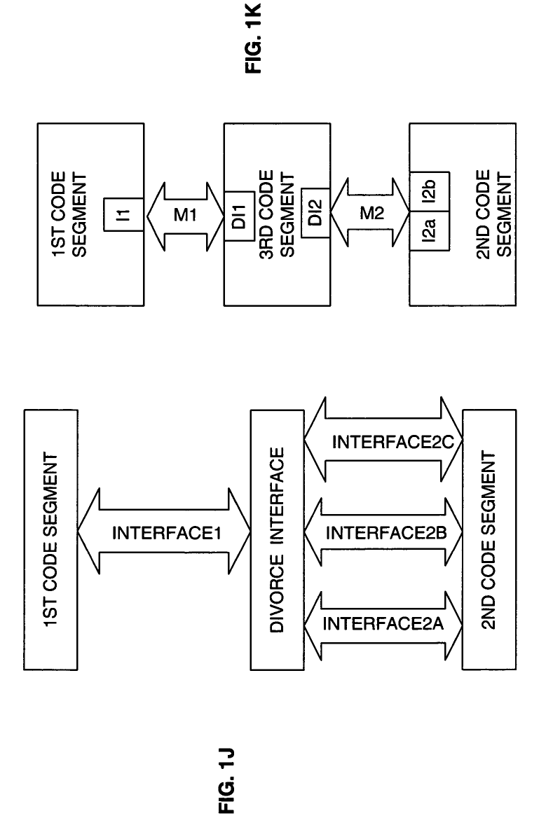

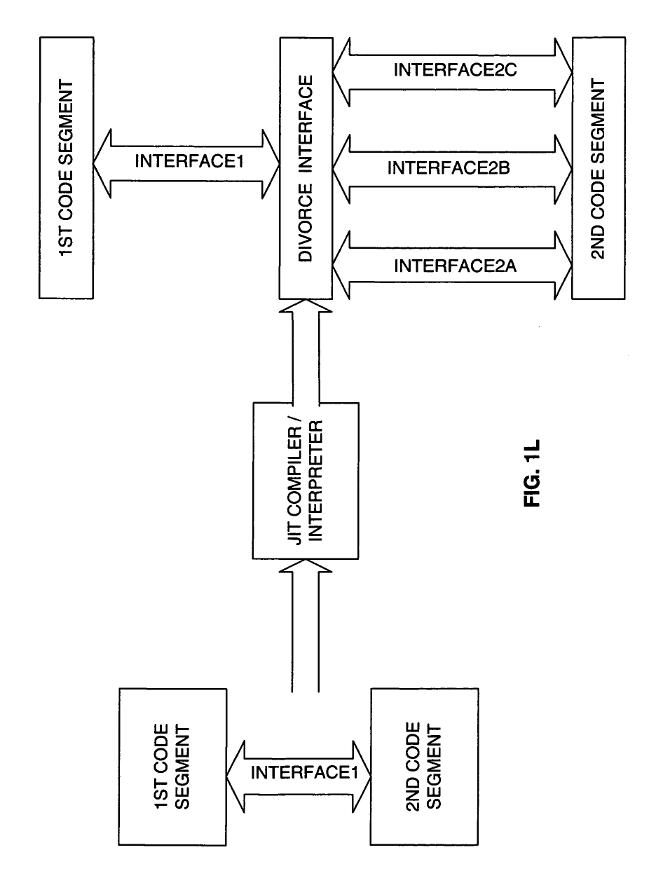

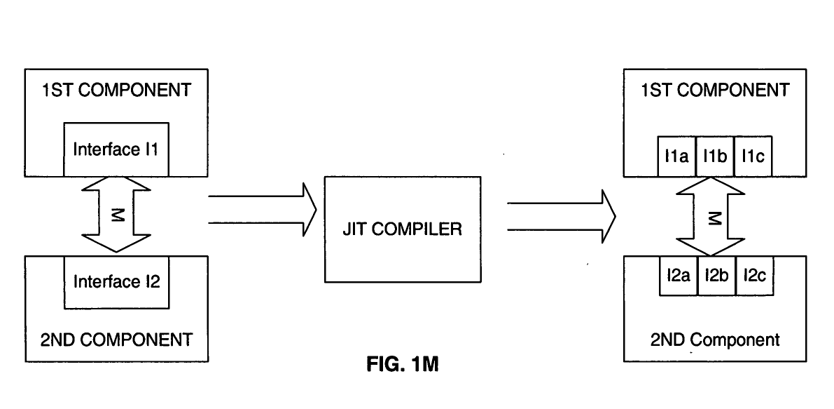

FIG. 1A illustrates an example of a suitable computing system environment in which the invention may be implemented. The computing system environment is only one example of a suitable computing environment and is not intended to suggest any limitation as to the scope of use or functionality of the invention. Neither should the computing environment of FIG. 1A be interpreted as having any dependency or requirement relating to any one or combination of components illustrated in the exemplary computing environment. Embodiments of the invention will also be described using as examples data structures found in various versions of the WINDOWS operating system. However, the invention is not limited to implementation in connection with a specific operating system.

The invention is operational with numerous other general purpose or special purpose computing system environments or configurations. Examples of well known computing systems, environments and/or configurations that may be suitable for use with the invention include, but are not limited to, personal computers, hand-held or laptop devices, multiprocessor systems, microprocessor-based systems, minicomputers, and the like. The invention is described in the general context of computer-executable instructions, such as program modules, being executed by a computer. Generally, program modules include routines, objects, components, data structures, etc. that perform particular tasks or implement particular abstract data types.

With reference to FIG. 1A, an exemplary system for implementing the invention includes a general purpose computing device in the form of a computer 1. Hardware components of computer 1 may include, but are not limited to, processing unit 2, system memory 4 and system bus 6 that couples various system components (including system memory 4) to processing unit 2. System bus 6 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus and Peripheral Component Interconnect (PCI) bus also known as Mezzanine bus.

Computer 1 typically includes a variety of computer readable media. Computer readable media can be any available media that can be accessed by computer 1 and includes both volatile and nonvolatile media, removable and non-removable media. By way of example, and not limitation, computer readable media may include computer storage media and communication media. Computer storage media includes volatile and nonvolatile, and removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

System memory 4 includes computer storage media in the form of volatile and/or nonvolatile memory such as read only memory (ROM) 8 and random access memory (RAM) 10. Basic input/output system 12 (BIOS), containing the basic routines that help to transfer information between elements within computer 1, such as during start-up, is typically stored in ROM 8. RAM 10 typically contains data and/or program modules that are immediately accessible to and/or presently being operated on by processing unit 2. By way of example, and not limitation, FIG. 1A illustrates operating system (OS) 14, application programs 16, other program modules 18 and program data 20.

Computer 1 may also include other removable/non-removable, volatile/nonvolatile computer storage media. By way of example only, FIG. 1A illustrates hard disk drive 22 that reads from or writes to non-removable, nonvolatile magnetic media, magnetic disk drive 24 that reads from or writes to removable, nonvolatile magnetic disk 26 and optical disk drive 28 that reads from or writes to removable, nonvolatile optical disk 30 such as a CD ROM, CDRW, DVD or other optical media. Other removable/non-removable, volatile/nonvolatile computer storage media that can be used in the exemplary operating environment include, but are not limited to, magnetic tape cassettes, flash memory cards, digital video tape, solid state RAM, solid state ROM, and the like. Hard disk drive 22 is typically connected to system bus 6 through a non-removeable memory interface such as interface 32, and magnetic disk drive 24 and optical disk drive 28 are typically connected to system bus 6 by a removable memory interface, such as interfaces 34 and 36.

The drives and their associated computer storage media, discussed above and illustrated in FIG. 1A, provide storage of computer readable instructions, data structures, program modules and other data for computer 1. In FIG. 1A, for example, hard disk drive 22 is illustrated as storing OS 38, application programs 40, other program modules 42 and program data 44. Note that these components can either be the same as or different from OS 14, application programs 16, other program modules 18 and program data 20. OS 38, application programs 40, other program modules 42 and program data 44 are given different numbers here to illustrate that, at a minimum, they are different copies. A user may enter commands and information into computer 1 through input devices such as keyboard 46, pointing device 48 (shown as a mouse, but which could be a trackball or touch pad) and stylus 71 (shown in conjunction with digitizer 65). Other input devices (not shown) may include a microphone, joystick, game pad, satellite dish, scanner, or the like. These and other input devices are often connected to processing unit 2 through user input interface 50 that is coupled to the system bus. Although mouse 48, keyboard 46, digitizer 65 and modem 66 are shown in FIG. 1A as connected to computer 1 through a serial port, these and other devices may be connected to computer 1 through other ports (e.g., a parallel port, PS/2 port, game port or a universal serial bus (USB) port) and related interfaces and structures. Monitor 52 or other type of display device is also connected to system bus 6 via an interface, such as video interface 54. In addition to the monitor, computers may also include other peripheral output devices such as speakers (not shown) and a printer (not shown), which may be connected through an output peripheral interface (not shown).

Computer 1 may operate in a networked environment using logical connections to one or more remote computers, such as remote computer 56. Remote computer 56 may be a personal computer, a server, a router, a network PC, a peer device or other common network node, and typically includes many or all of the elements described above relative to computer 1, although only memory storage device 58 has been illustrated in FIG. 1A. The logical connections depicted in FIG. 1A include local area network (LAN) 60 and wide area network (WAN) 62, but may also include other networks. Such networking environments are commonplace in offices, enterprise-wide computer networks, intranets and the Internet.

When used in a LAN networking environment, computer 1 is connected to LAN 60 through network interface or adapter 64. When used in a WAN networking environment, computer 1 may include modem 66 or other means for establishing communications over WAN 62, such as the Internet. Computer 1 may also access WAN 62 and/or the Internet via network interface 64. Modem 66, which may be internal or external, may be connected to system bus 6 via user input interface 50 or other appropriate mechanism. In a networked environment, program modules depicted relative to computer 1, or portions thereof, may be stored in the remote memory storage device. By way of example, and not limitation, FIG. 1A illustrates remote application programs 68 as residing on memory device 58. It will be appreciated that the network connections shown are exemplary and other means of establishing a communications link between computers may be used.

II. Example Programming Interfaces

A programming interface (or more simply, interface) may be viewed as any mechanism, process or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming (or program) interface (API), entry point, method, function, subroutine, remote procedure call, and component object model (COM) interface, are encompassed within the definition of programming interface.

A programming interface may be viewed generically as shown in FIG. 1B or FIG. 1C. FIG. 1B illustrates an interface Interface1 as a conduit through which first and second code segments communicate. FIG. 1C illustrates an interface as comprising interface objects I1 and I2 (which may or may not be part of the first and second code segments), which enable first and second code segments of a system to communicate via medium M. In the view of FIG. 1C, one may consider interface objects I1 and I2 as separate interfaces of the same system and one may also consider that objects I1 and I2 plus medium M comprise the interface. Although FIGS. 1B and 1C show bi-directional flow and interfaces on each side of the flow, certain implementations may only have information flow in one direction and/or may only have an interface object on one side.

Aspects of a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this description should be considered illustrative and non-limiting.

The concept of a programming interface is known to those skilled in the art. There are various other ways to implement a programming interface. Such other ways may appear to be more sophisticated or complex than the simplistic view of FIGS. 1B and 1C, but they nonetheless perform a similar function to accomplish the same overall result. Some illustrative alternative implementations of a programming interface are described in connection with FIGS. 1D-1M.

Factoring. A communication from one code segment to another may be accomplished indirectly by breaking the communication into multiple discrete communications. This is depicted schematically in FIGS. 1D and 1E. As shown, some interfaces can be described in terms of divisible sets of functionality. Thus, the interface functionality of FIGS. 1B and 1C may be factored to achieve the same result, just as one may mathematically provide 24, or 2 times 2 times 3 times 2. Accordingly, as illustrated in FIG. 1D, the function provided by interface Interface1 may be subdivided to convert the communications of the interface into multiple interfaces Interface1A, Interface1B, Interface1C, etc. while achieving the same result. As illustrated in FIG. 1E, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 1D and 1E, the functional spirit of interfaces Interface1 and I1 remain the same as with FIGS. 1B and 1C, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

Redefinition. In some cases, it may be possible to ignore, add or redefine certain aspects (e.g., parameters) of a programming interface while still accomplishing the intended result. This is illustrated in FIGS. 1F and 1G. For example, assume interface Interface1 of FIG. 1B includes a function call Square(input, precision, output), a call that includes three parameters (“input,” “precision” and “output”) and which is issued from the 1st Code Segment to the 2nd Code Segment. If the middle parameter (“precision”) is of no concern in a given scenario, as shown in FIG. 1F, it could be ignored, or replaced with another parameter. In either event, the functionality of Square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 1G, interface I1 is replaced by interface I1′, redefined to ignore or add parameters to the interface. Interface I2 may similarly be redefined (as interface I2′) to ignore unnecessary parameters, or parameters that may be processed elsewhere. As is clear from the foregoing, a programming interface may in some cases include aspects such as parameters which are not needed for some purpose, and which may be ignored, redefined, or processed elsewhere for other purposes.

Inline Coding. It may also be feasible to merge some or all of the functionality of two separate code modules such that the “interface” between them changes form. For example, the functionality of FIGS. 1B and 1C may be converted to the functionality of FIGS. 1H and 1I, respectively. In FIG. 1H, the previous 1st and 2nd Code Segments of FIG. 1B are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 1I, part (or all) of interface I2 from FIG. 1C may be written inline into interface I1 to form interface I1″. As illustrated, interface I2 is divided into I2a and I2b, and interface portion I2a has been coded in-line with interface I1 to form interface I1″.

Divorce. A communication from one code segment to another may be accomplished indirectly by breaking the communication into multiple discrete communications. This is depicted schematically in FIGS. 1J and 1K. As shown in FIG. 1J, one or more piece(s) of middleware (Divorce Interface(s), since they divorce functionality and/or interface functions from the original interface) are provided to convert the communications on the first interface, Interface1, to conform them to a different interface, in this case interfaces Interface2A, Interface2B and Interface2C. This might be done, e.g., where there is an installed base of applications designed to communicate with, say, an operating system in accordance with an Interface1 protocol, but then the operating system is changed to use a different interface, in this case interfaces Interface2A, Interface2B and Interface2C. The point is that the original interface used by the 2nd Code Segment is changed such that it is no longer compatible with the interface used by the 1st Code Segment, and so an intermediary is used to make the old and new interfaces compatible. Similarly, as shown in FIG. 1K, a third code segment can be introduced with divorce interface DI1 to receive the communications from interface I1 and with divorce interface DI2 to transmit the interface functionality to, for example, interfaces I2a and I2b, redesigned to work with DI2, but to provide the same functional result. Similarly, DI1 and DI2 may work together to translate the functionality of interfaces I1 and I2 of FIG. 1C to a new operating system, while providing the same or similar functional result.

Rewriting. Yet another possible variant is to dynamically rewrite code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the .Net framework, the Java runtime environment, or other similar runtime type environments). The JIT compiler may be written so as to dynamically convert the communications from the 1st Code Segment to the 2nd Code Segment, i.e., to conform them to a different interface as may be required by the 2nd Code Segment (either the original or a different 2nd Code Segment). This is depicted in FIGS. 1L and 1M. As can be seen in FIG. 1L, this approach is similar to the Divorce scenario described above. It might be done, e.g., where an installed base of applications are designed to communicate with an operating system in accordance with an Interface1 protocol, but then the operating system is changed to use a different interface. The JIT Compiler could be used to conform the communications on the fly from the installed-base applications to the new interface of the operating system. As depicted in FIG. 1M, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 1B and 1C. It is also noted that, as with most programming constructs, there are other similar ways of achieving the same or similar functionality of an interface which may not be described herein, but nonetheless are represented by the spirit and scope of the invention.

III. Task Page Dialogs

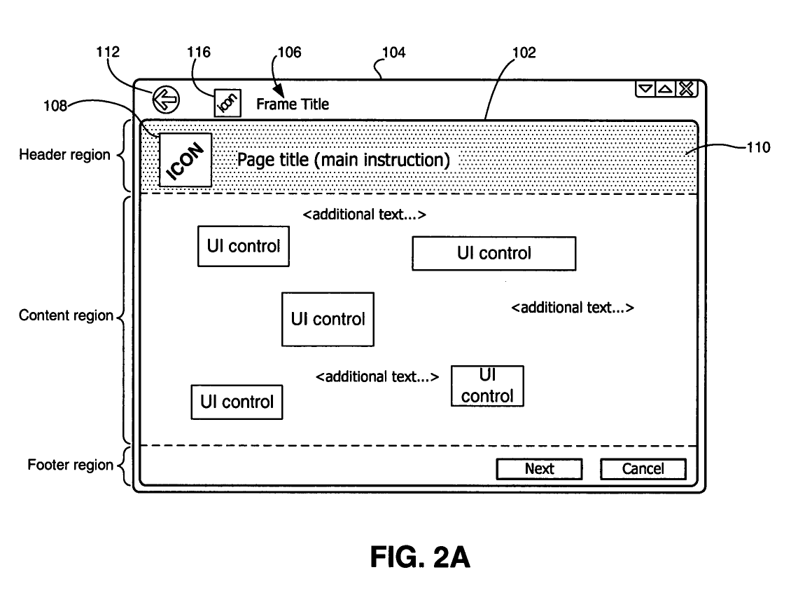

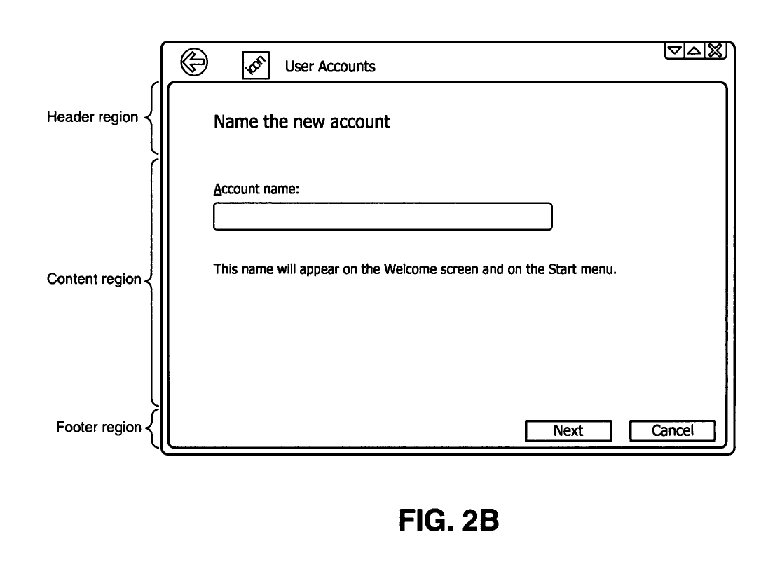

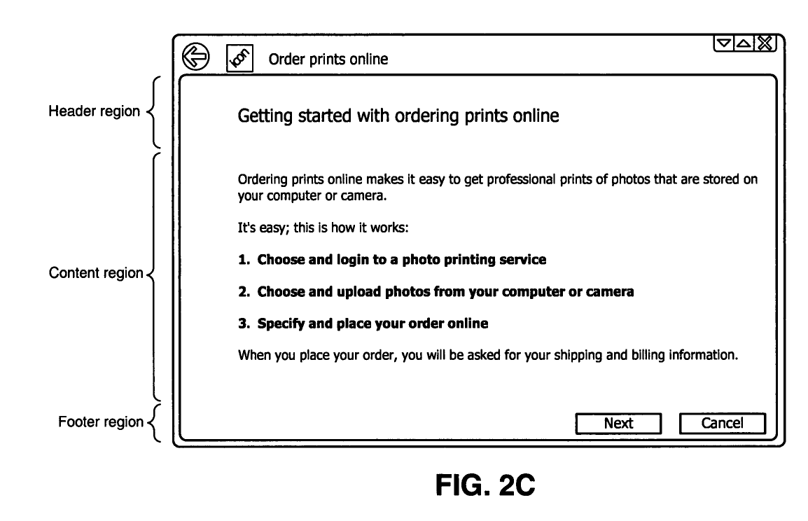

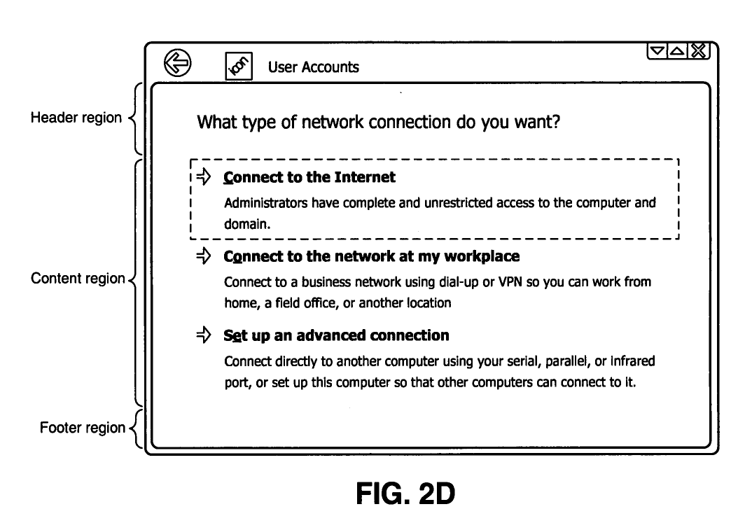

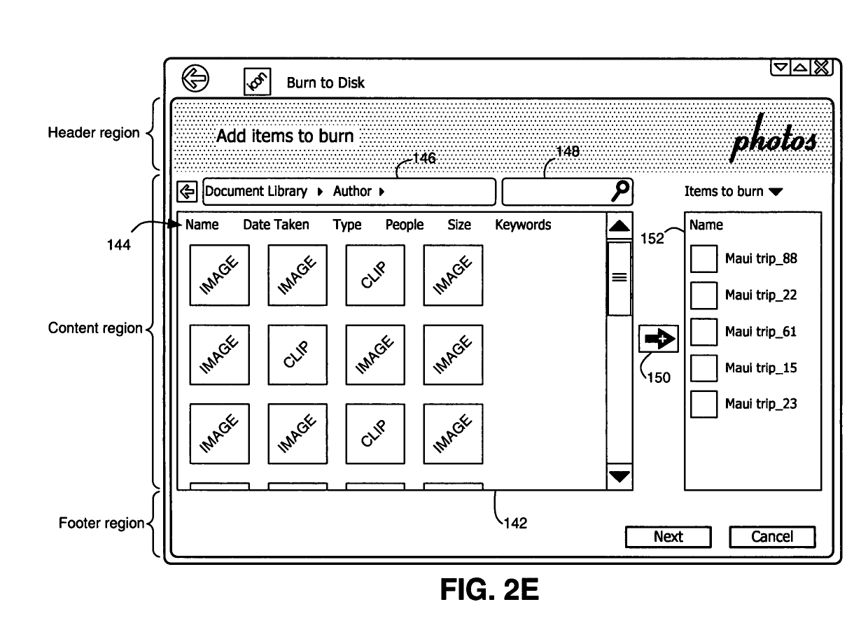

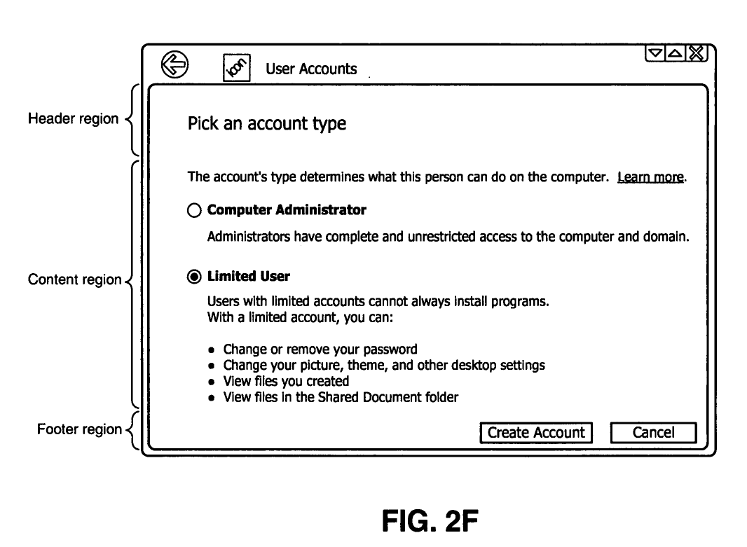

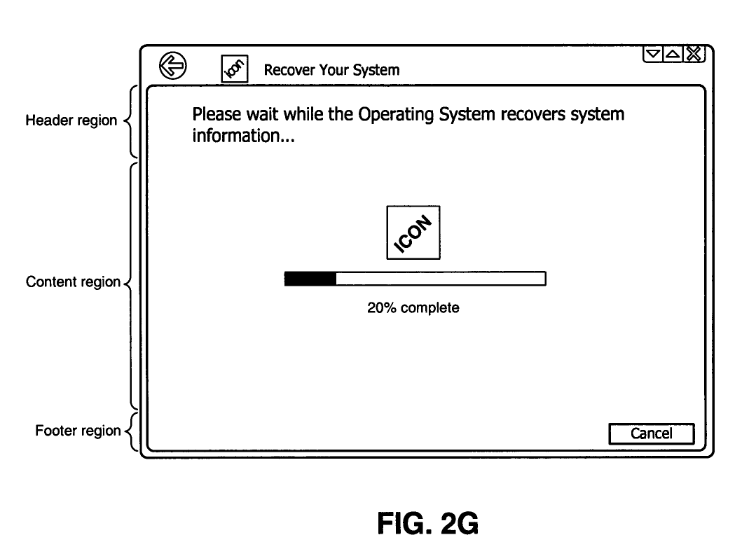

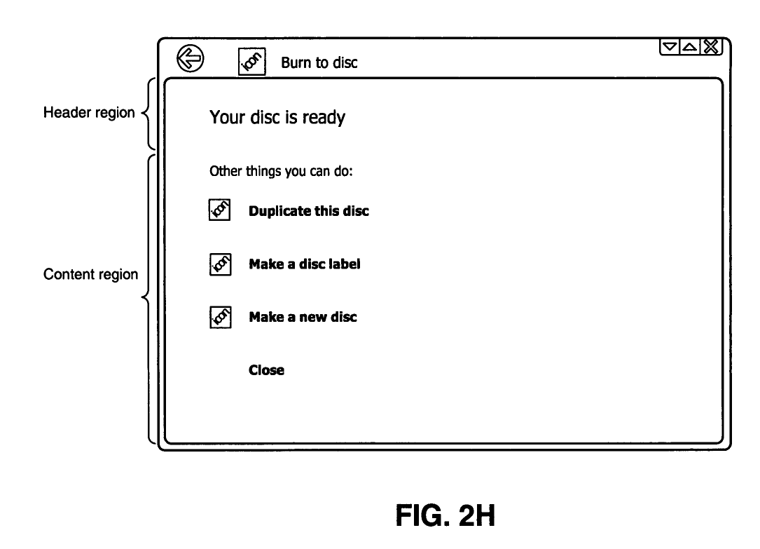

As used herein, a “task page dialog” (or “task page”) is a specialized type of dialog used when a decision or other information is needed from a user in order to continue a task or series of tasks. In many cases, a task page dialog will be part of a series of such dialogs for related tasks. FIGS. 2A-2H show examples of task page dialogs according to at least some embodiments of the invention. Although the dialogs shown in FIGS. 2A-2H are all shown as independent windows in a GUI generated by an OS (such as various versions of the WINDOWS OS), the invention is not limited in this regard. For example, task page dialogs according to the invention might also be generated within some other type of frame (e.g., a pane of a pre-existing window).

Shown in FIG. 2A is a generic task page 102 according to at least some embodiments of the invention. Task page 102 has a format defined by an operating system (OS), and is contained within a frame 104. Frame 104, which may be a GUI window, may also contain additional task pages related to task page 102. For example, after a user completes the task addressed by task page 102 and presses the “next” button, a subsequent task page for a related task would replace task page 102 within frame 104. Frame 104 includes a title 106. In at least some embodiments, frame title 106 is the name of a wizard (e.g., “new program installation wizard”). Frame title 106 could also be some other description of a series of tasks for which task pages are being presented (e.g., “new hardware setup”). An icon 116 may be included in addition to title 106. Frame 104 also includes a return arrow 112 (discussed below) and controls which can be selected for minimizing, maximizing or closing frame 104.

The format of task page 102 includes a header region, a content region and a footer region. For convenience, these regions are separated with broken lines in FIG. 2A. As seen in subsequent figures, however, such broken lines would not necessarily appear in an actual task page. The header region includes a page title. The page title serves as a main instruction and informs the user of the purpose of the task page. In at least some embodiments, this main instruction is a single, concise sentence. Thus, even if the content region (described below) contains numerous controls requiring multiple decisions, the user can know from the page title what he or she is trying to do. Also included in the header region is an anchor image 108 and a background 110. Anchor image 108 can be an icon. In some embodiments, anchor image 108 could also be animated. The same anchor image can be used for multiple task pages in a series of task pages, or each task page could have a different anchor image. For purposes of simplicity, icons and other images will be represented generically in the drawings as boxes. Background 110 can be a bitmap, which can be specified by a developer, and over which the page title is imposed. The background can be used, e.g., to associate a task page with a company manufacturing the program which has caused the task page to be created. In at least some embodiments, the header background remains constant throughout multiple task pages in a series.

Below the header region is the content region. The content region may be used to provide additional text which further explains the task page and what is needed from the user. The content area may also contain UI controls with which the user can provide input. As used herein, a “UI control” includes various types of graphical elements which a user can select (by, e.g., hovering a cursor over the control and pressing a mouse button) so as to interact with the computer program that caused the task page to be created. UI controls include, but are not limited to, buttons, “radio” buttons, check boxes, text input boxes, expansion controls, scrolling text boxes, etc. UI controls also include graphical elements which only provide information to a user (i.e., which do not offer a user the chance to select something). One example of such an information-only control is a progress indicator bar showing the percentage of a task or internal computer process which has been completed (e.g., a bar showing the percentage of a file that has been downloaded).

In FIG. 2A, the content region is shown with an arbitrary number of randomly arranged UI controls and text portions. In at least some embodiments, the content region is specified with a dialog box template as is used in various versions of the WINDOWS OS. As is known in the art, a dialog box template is binary data describing a dialog box and defining the height, width, style and control(s) within the dialog box. Dialog box templates can be created with, e.g., resource compilers or dialog box editors. Unlike known methods of dialog creation, which rely on a dialog box template to define an entire dialog, embodiments of the invention package dialog box templates within task pages. In this manner, developers are assisted in linking related dialogs and in conforming to good design practices.

Beneath the content region is the footer region. The footer region houses controls for moving to another task page and/or for canceling (or otherwise closing) the current task page. In the example of FIG. 2A, two button controls are provided. One of the buttons (labeled “next”) allows a user to proceed to the next task page in a series after providing any required input to UI controls (not shown) in the content region. Another of the buttons (labeled “cancel”) allows a user to close the task page without completing any required input. Depending on the dialog box template inserted into the content region and on other programming choices made by a developer, pressing a “cancel” button could result in returning to a previous dialog, closing frame 104 (e.g., canceling an entire series of related tasks), or other consequences. The text used for buttons in the footer region can also be specified by a developer. For example, in a task page asking a user to select a phone number to be dialed, text for the “next” button could be replaced with “dial.” The size of the buttons in the footer region is automatically expanded to accommodate longer button labels.

As shown in FIG. 2A, the footer region may not contain a conventional “back” button allowing a user to return to a previous page. Instead, when a developer chooses to allow such backtracking, a return arrow control 112 is included in frame 104. This reverse arrow is similar to a “back” arrow provided by many browser programs, thereby providing a familiar visual clue to a task page user. In other embodiments, a “back” button is used in the footer region instead of the arrow shown in FIG. 2A.

FIGS. 2B through 2H provide more specific examples of possible task pages. In FIG. 2B, the header region includes a main instruction advising the user to name a new user account, and has no anchor image. The content region includes a text entry control and additional explanatory text regarding the requested input. FIG. 2C is an example of a task page which has no UI controls in the content region. Instead, the main instruction in the header region advises the user that he or she is about to begin a series of tasks (“ordering prints online”), and the content region is used to provide additional details of what is to come in subsequent task pages. The user can then proceed to the next task page (by pressing the “next” button) or cancel the entire series of task pages (by pressing the “cancel” button).

FIG. 2D is an example of a task page having command links in the content region. Command link controls are described in commonly owned U.S. patent application Ser. No. ______ (attorney docket no. 003797.01229, filed on the same date as the present application), titled “Command Links” and incorporated by reference herein. As described more fully therein, each command link includes a glyph (small arrows in FIG. 2D), a main text portion (e.g., “Connect to the Internet”), and an explanatory text portion (e.g., “Administrators have complete and unrestricted access . . . ”). When the user hovers a cursor over one of the command links, the entire command link is highlighted with, e.g., an outline. In the example of FIG. 2D, the “Connect to the Internet” command link is highlighted. When the command link is selected (by, e.g., pressing a mouse button), a response as indicated by the main text portion of the command link is initiated. As also shown in FIG. 2D, a footer region (as well as “next” and “cancel” buttons) is not necessarily required. Depending upon how a developer designs a series of task pages, selecting a control (e.g., a command link) with the content region can result in termination of one task page and initiation of a succeeding (or redisplay of a preceding) task page.

FIG. 2E is an example of a task page having a more complex collection of UI controls (and related input options) in the content region. The task page of FIG. 2E is directed to selecting image or video files for copying (or “burning”) onto a compact disk, and includes a header bitmap (a stippled pattern with a script “photos” on the right side). The UI controls in the content region include a box 142 for selection of individual image or video files. Another control includes elements 144 which a user can select to display various data (“name,” “date taken,” “type,” etc.) about each of the files in box 142. A directory control 146 allows a user to select a directory in which other image or video files might be contained, and a search window control 148 allows a user to type in text and search for a particular file. A control 150 allows a user to indicate that a file selected in box 142 is to be copied to a CD, and causes a smaller thumbnail for the selected file to be included in box 152. Despite the number of controls and complexity of the content region, however, the main instruction (“add items to burn”) allows a user to remain focused upon the task for which the page is presented.

FIG. 2F is an example of a task page having “radio button” controls in the content region, as well as a customized label (“create account”) for a button in the footer region. FIG. 2G is another example of a task page which does not request user input in the content region, and instead only conveys information to the user. In the example of FIG. 2G, the content region contains a progress control informing the user how much of a particular process (recovering system information) has been completed by the operating system. FIG. 2H is an example of a task page in which the content region presents a user with options for additional series of follow-up tasks. In the example of FIG. 2H, the main instruction indicates that a disc being “burned” is ready. Selecting the first command link in the content region allows a user to initiate a new series of task pages for copying the newly-burned disk. Selecting the second command link initiates a series of task pages for creating a label for the newly burned disk. Selecting the third option allows the user to repeat the just completed task pages for the purpose of creating a new disk. If the user desires to simply end the task page without starting a new series of tasks, the “close” command link can be selected.

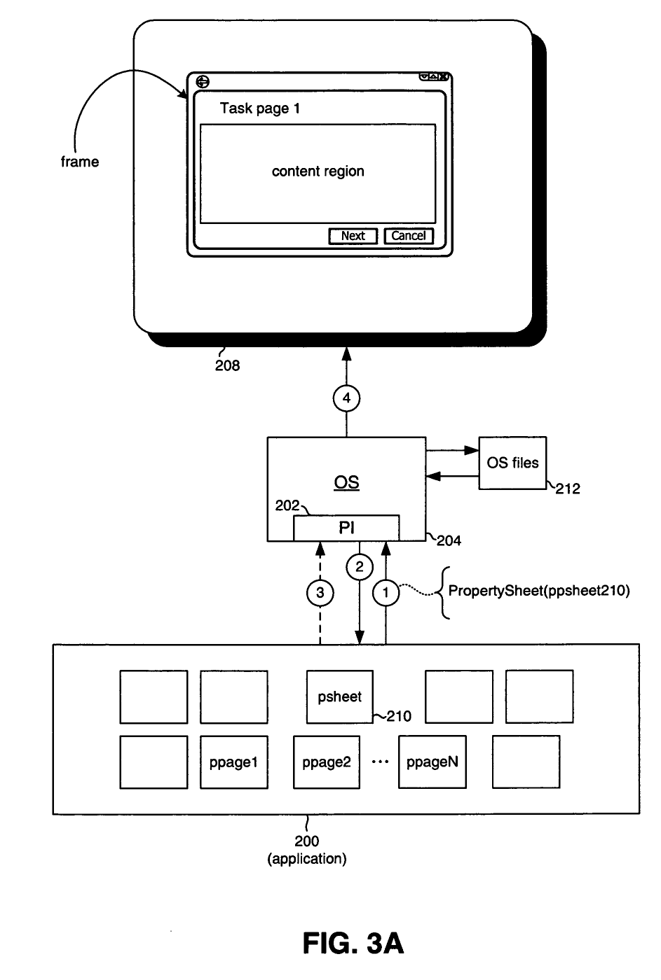

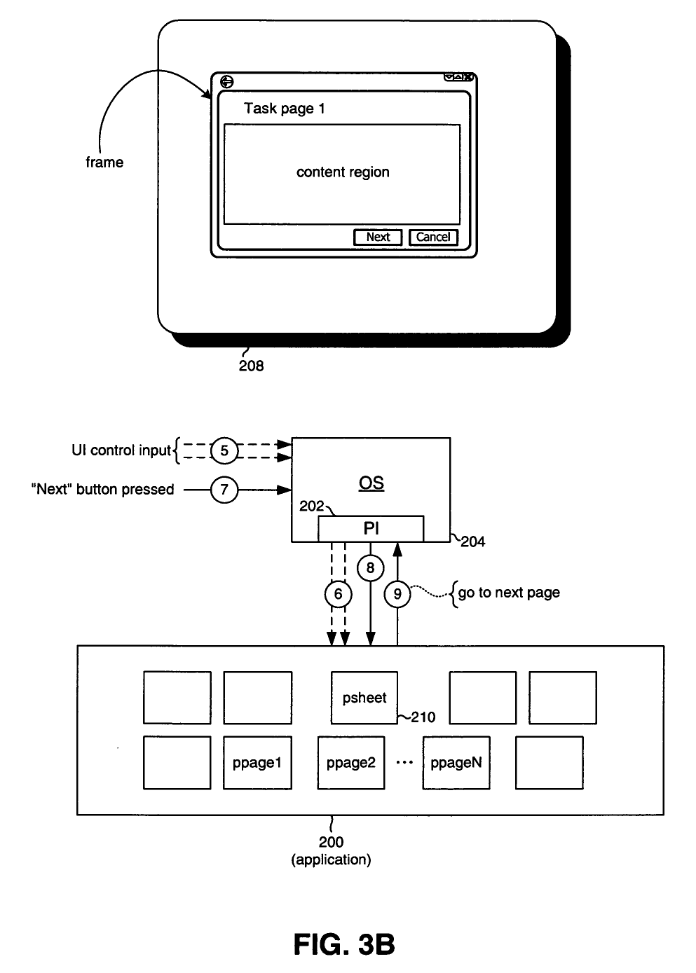

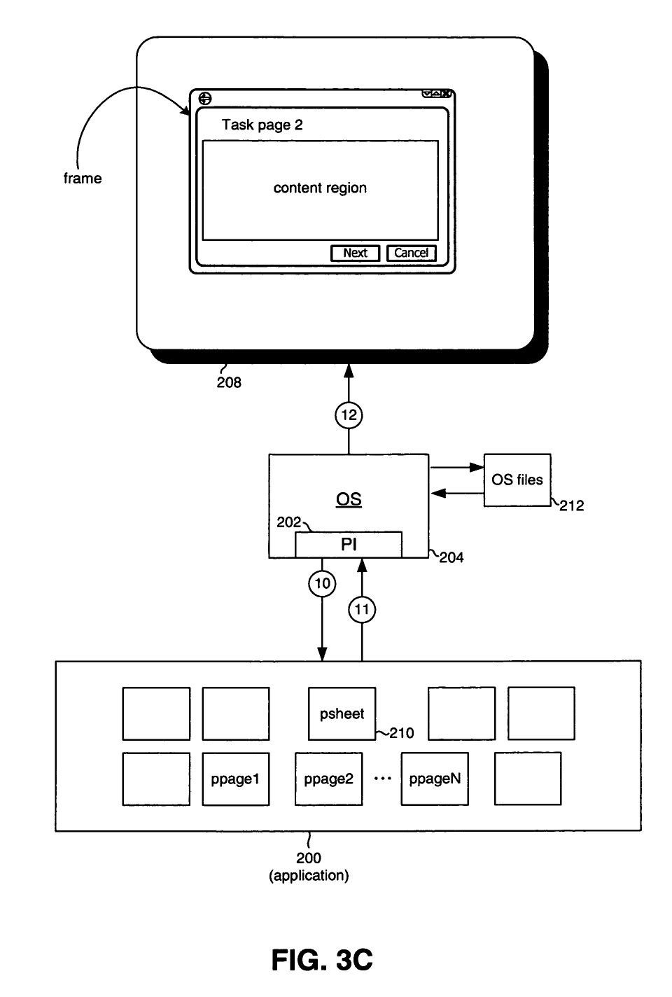

FIGS. 3A-3C show, in diagrammatic form, how an application program can cause an OS to create task pages according to at least some embodiments of the invention. Shown at the bottom of FIG. 3A is a block representing an arbitrary application program 200. Because application programs typically include a plurality of separate program files and other components, application program 200 is shown in FIG. 3A as a larger box surrounding multiple smaller boxes. Each of the smaller boxes may represent separate files or separate portions of individual files. More than one file within application 200 may be able to request creation of task pages. Also included within application 200 is at least one property sheet 210 (“psheet”). As described in more detail below, property sheet includes data or references to data (e.g., pointers) which application 200 provides to OS 204 via programming interface (PI) 202 in order to create a series of task pages. Although only a single property sheet is shown, an application could contain multiple property sheets. Property sheet 210 in turn refers to one or more property pages. In the example of FIGS. 3A-3C, property sheet 210 refers to an arbitrary number of property pages 1 (“ppage1”) through N (“ppageN”). As also described below, each property sheet includes data or references to data which describes an individual task page.

Application 200 requests generation of task pages 1 through N (corresponding to property pages 1 through N) by transmitting that request to PI 202. Although shown in FIG. 3A as a part of OS 204, PI 202 can be implemented in various of the manners described in connection with FIGS. 1B through 1M. PI 202 includes one or more functions or methods which application 200 accesses through one or more calls, messages or other types of communication. In at least some embodiments, application 200 requests creation of a task page (or series of task pages) by calling such a function and specifying a property sheet (which in turn specifies one or more property pages). This is shown diagrammatically in step 1 of FIG. 3A. In particular, application 200 calls a function (“PropertySheet”) having a pointer to property sheet 210 (ppsheet210). Property sheet 210 includes data indicating the task pages that OS 204 is to display, as well as how OS 204 should display the frame that will contain those task pages. Examples of data that property sheet 210 may contain (or reference by pointers or otherwise) include:
a style to be used when generating the frame for the task pages (e.g., text fonts, colors, margins and other offsets, etc.),
if the frame will be resizable by a user,
if a callback function should be called by OS 204 upon initializing or destroying the frame (and if so, the identity of that function),
the icon for use in the frame title bar,
the frame title,
the property pages to be displayed as task pages (in the example, ppage1-ppageN),
the property page to be displayed as the initial task page when the frame is initially displayed, and
the bitmap to be used in the task page headers.

In turn, each of the property pages 1-N referenced by property sheet 10 includes data or references to data pertaining to a corresponding task page. Examples of such data include:
the identity (or memory location) of the dialog box template to be used for the content region of the task page,
if a callback function should be called by OS 204 upon initializing or destroying the task page (and if so, the identity of that function),
the dialog box procedure to be called by OS 204 in connection with the dialog displayed in the content region,
the icon to be used as the anchor image, and
the main instruction.

When the PropertySheet call is received by PI 202, OS 204 sends one or more messages to application 200 indicating that OS 204 is about to create the frame and the first of the property pages specified by the function call. This is shown in FIG. 3A as step 2. In response to these messages, application 200 may do nothing, or may take various steps to prepare for the upcoming task dialog(s). For example, the content region controls of one or more of the upcoming the task page dialogs may require information about the current state of the computer on which application 200 is running. In such a case, application 200 might then gather that information from the appropriate sources so as to initialize controls when the task page(s) are shown. As another example, and as described below, application 200 might respond to a message with an instruction to hide or re-label a control button in the footer region of a task page. Possible responses by application 200 to the messages of step 2 are shown as a broken line arrow in step 3. Although FIG. 3A shows a single message in step 2 and a single message in step 3, there may actually be a series of such messages between OS 204 and application 200 prior to creation of the first task page on display 208, which is shown as step 4. When OS 204 creates task page 1, the arrangement of the header, content and footer (if present) regions, as well as the style of the header title and other page elements, are controlled by parameters in one or more OS files 212.

After creating the initial task page, and as shown in FIG. 3B, a user provides input to the computer by interacting with UI controls in the content region of task page 1. The form of this input would depend on the design of the content region, and could include multiple inputs. These UI control inputs are shown as broken line arrows in FIG. 3B (step 5). OS 204 then sends one or more messages to application 200 (step 6) to convey the UI control input. When the user has completed input to the content region of task page 1, the user then selects a “next” button in the footer region (step 7). OS 204 then sends a message to application 200 indicating that the user has pressed the “next” button (step 8). In some embodiments having command links in a task page, steps 5 and 7 may be combined into a single input, and steps 6 and 8 may be combined into a single message.

Application 200 responds to the “next” button message at step 9. That response may be an indication that OS 204 should proceed to the next task page. In some cases, however, application 200 could respond that OS 204 should not proceed to the next task page. For example, the content region of task page 1 may require certain data in order to complete a particular task. If the user has failed to enter that data (which application 200 would know based on data received or not received in step 6) before pressing the next button, application 200 can prevent the user from proceeding to the next task page until a valid data entry is provided. Application 200 might also send additional messages requesting OS 204 to display error messages (e.g., in a separate message box dialog), to highlight the portion of the content region requiring an input, etc.

Notably, data corresponding to UI control input (step 5) will not always be provided prior to user selection of a “next” button. For example, a task page content region could simply contain text information advising the user of subsequent steps to follow (similar to FIG. 2C). In such case, a user could press the next button to indicate that he or she has read the content area message and is ready to move on. There are other ways in which a user might terminate a task page without first providing input to a content area UI control. If the user had pressed a “cancel” button or otherwise closed task page 1 (e.g., with the “X”) without providing other input, OS 204 would send a message to application 200 indicating this had occurred. In response to a cancellation message, application 200 could indicate that the cancellation should proceed, thereby allowing the wizard or other series of dialogs to terminate. Application 200 might alternatively respond that the task page should not be canceled. For example, application 200 might notify OS 204 that cancellation should not be allowed, and that OS 204 should display another dialog to caution the user about the consequences of cancellation.

In the present example, however, application 200 informs OS 204 in step 9 that the next task page should be displayed. At step 10 (FIG. 3C), OS 204 sends a message to application 200 indicating that task page 2 is about to be created. Application 200 may send one or more messages in response (step 11). OS 204 then creates task page 2 (step 12), again referring to OS files 212. One or more of the previously described steps then continue for other task pages in the series, until a task page is canceled, or until application 200 otherwise instructs OS 204 to terminate the task pages. As one example, a particular response to an intermediate task page in a series might cause application 200 to determine that further task pages in the series are unnecessary. Similarly, a particular response to one of the task pages might cause application 200 to determine that one or more subsequent task pages should be skipped or replaced. When the final page is reached, a “finish” button message is transmitted by OS 204 to application 200 instead of a “next” button message.

In some embodiments, OS 204 provides certain default buttons for every task page. In particular, and unless otherwise specified by an application, all pages are displayed with a “cancel” button, all pages except the last are displayed with a “next” button, and the last page is displayed with a “finish” button. However, application 200 can instruct OS 204 (with one or more messages via PI 202) that one or more of these buttons should not be displayed in a particular task page. Similarly, application 200 can instruct OS 204 (with other messages via PI 202) that these buttons should be displayed with a different label. In some embodiments, a footer region may only contain a “next” (or “finish”) button.

Included at the end of this detailed description are Appendices A though GG describing functions, notifications, messages and structures, according to at least some embodiments, by which application 200 may access PI 202 to cause display of a series of task pages. Because Appendices A through GG will be readily understood by persons skilled in the art, they will not be extensively discussed herein. As can be seen in said appendices, however, various other messages and notifications can be exchanged as part of a process similar to the example of FIGS. 3A through 3C. Indeed, many variations upon the example of FIGS. 3A through 3C are available. For example, if an application developer wishes to include command links in a task page a “PSP_COMMANDLINKS” flag can be included in a PROPSHEETPAGE structure. Such a flag will cause the resulting task page to be displayed, e.g., without a footer region or a “next button.”

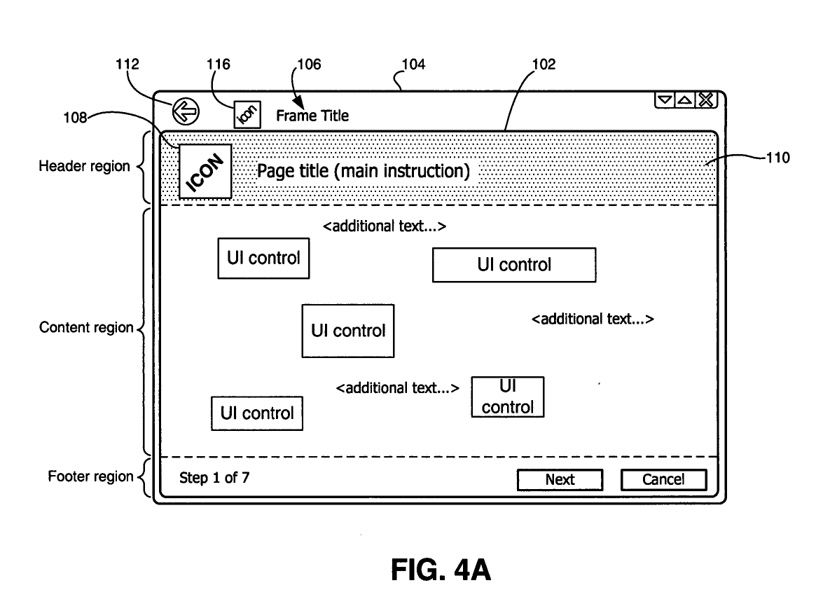

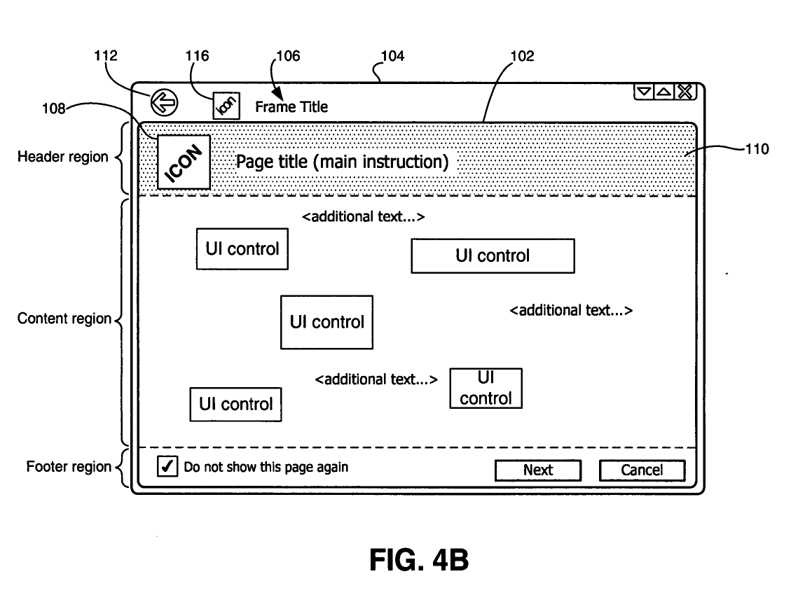

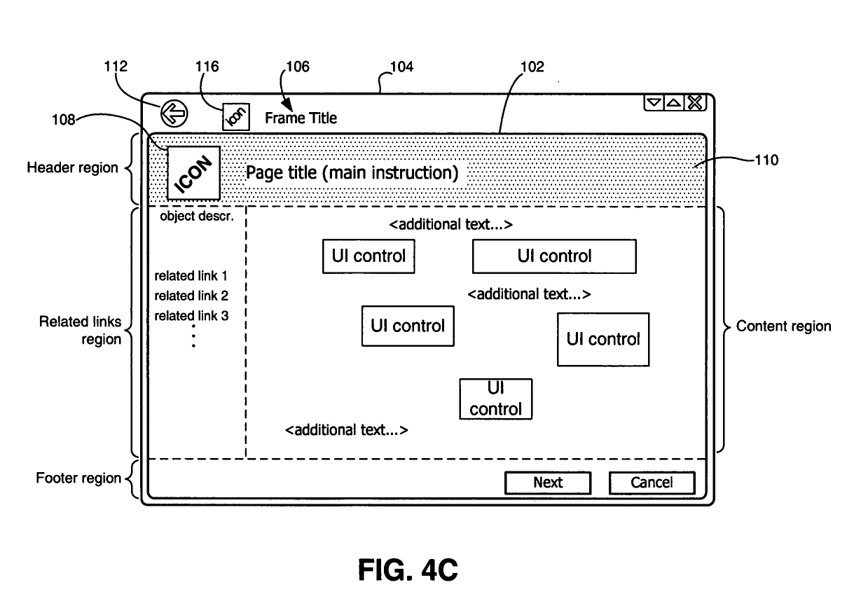

FIGS. 4A through 4C are examples of task pages according to additional embodiments of the invention. The task page of FIG. 4A is generally similar to that of FIG. 2A, but further includes an additional control in the footer region. Specifically, a control (“Step 1 of 7”) is included to indicate the step of multiple steps to which the task page corresponds. The task page of FIG. 4B includes a verification (or “check box”) control in the footer region. If the user selects this control and dismisses the task page (whether by pressing the “next” or “cancel” buttons or by pressing the “X” in the upper right corner), the result will be as specified in text next to the control. In FIG. 4B, the user can check “do not show this page again” to avoid being prompted in the future regarding the same series of tasks. In other circumstances, a verification control could be used to indicate that choices made in the content region should be applied in the future instead of redisplaying the same task page.

The task page of FIG. 4C is also similar to the task page of FIG. 2A, but further includes a related links region. The related links region can contain links to resources that support or are related to the task of the task page. If for example, the content region contains controls for selecting types of access rights for users of a computer system, the related links region might include links to pages providing additional description of the possible access rights. A related link can open a new window, can link to another task page, can have a state (similar to a tab), and/or can be implemented in other manners. In some embodiments, an additional textual description can be included in the related links and under the anchor image to, e.g., describe the type of object being acted upon by the task page.

Although specific examples of carrying out the invention have been described, those skilled in the art will appreciate that there are numerous other variations and permutations of the above described systems and techniques. As used in the claims, the phrase “data indicative of” includes pointers or other references to data located elsewhere, as well as the actual data itself. In the claims, various portions are prefaced with letter or number references for convenience. However, use of such references does not imply a temporal relationship not otherwise required by the language of the claims.

Appendix A

CreatePropertySheetPage Function

Creates a new page for a property sheet.

Syntax

HPROPSHEETPAGE CreatePropertySheetPage(
LPCPROPSHEETPAGE lppsp
);

Parameters

lppsp
Pointer to a PROPSHEETPAGE structure that defines a page to be included in a property sheet.
   Return Value

Returns the handle to the new property page if successful, or NULL otherwise.

Remarks

An application uses the PropertySheet function to create a property sheet that includes the new page.

Appendix B

DestroyPropertySheetPage Function

Destroys a property sheet page. An application must call this function for pages that have not been passed to the PropertySheet function.

Syntax

BOOL DestroyPropertySheetPage(
HPROPSHEETPAGE hPSPage
);

Parameters
hPSPage

Handle to the property sheet page to delete.

Return Value

Returns nonzero if successful, or zero otherwise.

Appendix C

PropertySheet Function

Creates a property sheet and adds the pages defined in the specified property sheet header structure.

Syntax

int PropertySheet(
LPCPROPSHEETHEADER lppsph
);

Parameters
lppsph

Pointer to a PROPSHEETHEADER structure that defines the frame and pages of a property sheet.

Return Value

Returns a positive value if successful, or −1 otherwise.

Remarks

To retrieve extended error information, call GetLastError.

Appendix D

PropSheetPageProc Function

Specifies an application-defined callback function that a property sheet calls when a page is created and when it is about to be destroyed. An application can use this function to perform initialization and cleanup operations for the page.

Syntax

```
UINT CALLBACK PropSheetPageProc(
  HWND hwnd,
  UINT uMsg,
  LPPROPSHEETPAGE ppsp
);
```

Parameters
hwnd

Reserved; must be NULL.

uMsg

[in] Action flag. This parameter can be one of the following values:

PSPCB_ADDREF
A page is being created. The return value is not used.
PSPCB_CREATE

A dialog box for a page is being created. Return nonzero to allow it to be created, or zero to prevent it.
PSPCB_RELEASE
A page is being destroyed. The return value is ignored.
   ppsp

[in, out] Pointer to a PROPSHEETPAGE structure that defines the page being created or destroyed. See the Remarks section for further discussion.

Return Value

The return value depends on the value of the uMsg parameter.

Remarks

An application must specify the address of this callback function in the pfnCallback member of a PROPSHEETPAGE structure before passing the structure to the CreatePropertySheetPage function.

Note: The property sheet is in the process of manipulating the list of pages when this function is called. Do not attempt to add, remove, or insert pages while handling this notification. Doing so will have unpredictable results.

With the exception of the lParam member, an application should not modify the PROPSHEETPAGE structure. Doing so will have unpredictable results. The lParam member contains application-defined data and can be modified as needed.

Appendix E

PropSheetProc Function

An application-defined callback function that the system calls when the property sheet is being created and initialized.

Syntax

```
int CALLBACK PropSheetProc(
  HWND hwndDlg,
  UINT uMsg,
  LPARAM lParam
);
```

Parameters
hwndDlg

Handle to the property sheet dialog box.

uMsg

Message being received. This parameter is one of the following values.
PSCB_BUTTONPRESSED

Indicates the user pressed a button in the property sheet dialog box. To enable this, specify PSH_USECALLBACK in PRINTPROPSHEETHEADER.dwFlags and specify the name of this callback function in PRINTPROPSHEETHEADER.pfnCallback. The lParam value is one of the following:

Button pressed lParam value

Cancel PSBTN_CANCEL
PSCB_INITIALIZED
Indicates that the property sheet is being initialized. The lParam value is
zero for this message.

lParam

Additional information about the message. The meaning of this value depends on the uMsg parameter.

Return Value

Returns zero.

Remarks

To enable a PropSheetProc callback function, use the PROPSHEETHEADER structure when you call the PropertySheet function to create the property sheet. Use the pfnCallback member to specify an address of the callback function, and set the PSP_USECALLBACK flag in the dwFlags member.

PropSheetProc is a placeholder for the application-defined function name. The PFNPROPSHEETCALLBACK type is the address of a PropSheetProc callback function.

Appendix F

PSN KILLACTIVE Notification

Notifies a page that it is about to lose activation either because another page is being activated or the user has clicked the OK button. This notification message is sent in the form of a WM_NOTIFY message.

Syntax

PSN_KILLACTIVE
lppsn = (LPPSHNOTIFY) lParam;

Parameters
lppsn

Pointer to a PSHNOTIFY structure that contains information about the notification. This structure contains an NMHDR structure as its first member, hdr. The hwndFrom member of this NMHDR structure contains the handle to the property sheet. The lParam member of the PSHNOTIFY structure does not contain any information.

Return Value

Returns TRUE to prevent the page from losing the activation, or FALSE to allow it.

Remarks

An application handles this notification to validate the information the user has entered.

Note: The property sheet is in the process of manipulating the list of pages when the PSN_KILLACTIVE notification is sent. Do not attempt to add, remove, or insert pages while handling this notification. Doing so will have unpredictable results.

To set a return value, the dialog box procedure for the page must call the SetWindowLong function with a DWL_MSGRESULT value set to the return value. The dialog box procedure must return TRUE.

If the dialog box procedure sets DWL_MSGRESULT to TRUE, it should display a message box to explain the problem to the user.

Appendix G

PSN QUERYCANCEL Notification

Indicates that the user has canceled the property sheet. This notification message is sent in the form of a WM_NOTIFY message.

Syntax

PSN_QUERYCANCEL
lppsn = (LPPSHNOTIFY) lParam;

Parameters
lppsn

Pointer to a PSHNOTIFY structure that contains information about the notification. This structure contains an NMHDR structure as its first member, hdr. The hwndFrom member of this NMHDR structure contains the handle to the property sheet. The lParam member of the PSHNOTIFY structure does not contain any information.

Return Value

Returns TRUE to prevent the cancel operation, or FALSE to allow it.

Remarks

This message is typically sent when a user clicks the Cancel button. It is also sent when a user clicks the X button in the property sheet's upper right hand corner or presses the ESCAPE key. A property sheet page can handle this notification message to ask the user to verify the cancel operation.

To set a return value, the dialog box procedure for the page must call the SetWindowLong function with DWL_MSGRESULT set to the return value. The dialog box procedure must return TRUE.

Appendix H

PSN RESET Notification

Notifies a page that the property sheet is about to be destroyed. This notification message is sent in the form of a WM_NOTIFY message.

Syntax

PSN_RESET
lppsn = (LPPSHNOTIFY) lParam;

Parameters
lppsn

Pointer to a PSHNOTIFY structure that contains information about the notification.

Return Value

No return value.

Remarks

The lParam member of the PSHNOTIFY structure pointed to by lppsn will be set to TRUE if the user clicked the “X” button in the upper-right corner of the property sheet. It will be FALSE if the user clicked the Cancel button. The PSHNOTIFY structure contains an NMHDR structure as its first member, hdr. The hwndFrom member of this NMHDR structure contains the handle to the property sheet.

An application can use this notification message as an opportunity to perform cleanup operations.

Note: The property sheet is in the process of manipulating the list of pages when the PSN_RESET notification is sent. Do not attempt to add, remove, or insert pages while handling this notification. Doing so will have unpredictable results.

Do not call the EndDialog function when processing this notification.

Appendix I

PSN SETACTIVE Notification

Notifies a page that it is about to be activated. This notification message is sent in the form of a WM_NOTIFY message.

Syntax

PSN_SETACTIVE
lppsn = (LPPSHNOTIFY) lParam;

Parameters
lppsn

Pointer to a PSHNOTIFY structure that contains information about the notification. This structure contains an NMHDR structure as its first member, hdr. The hwndFrom member of this NMHDR structure contains the handle to the property sheet. The lParam member of the PSHNOTIFY structure does not contain any information.

Return Value

Returns zero to accept the activation, or −1 to activate the next or the previous page (depending on whether the user clicked the Next or Back button). To set the activation to a particular page, return the resource identifier of the page.

Remarks

The PSN_SETACTIVE notification message is sent before the page is visible. An application can use this notification to initialize data in the page.

Note: The property sheet is in the process of manipulating the list of pages when the PSN_SETACTIVE notification is sent. Do not attempt to add, remove, or insert pages while handling this notification. Doing so will have unpredictable results.

To set the return value, the dialog box procedure for the page must use the SetWindowLong function with the DWL_MSGRESULT value, and the dialog box procedure must return TRUE.

Appendix J

PSN TRANSLATEACCELERATOR Notification

Notifies a property sheet that a keyboard message has been received. It provides the page an opportunity to do private keyboard accelerator translation. This notification is sent in the form of a WM_NOTIFY message.

Syntax

PSN_TRANSLATEACCELERATOR
lppsn = (LPPSHNOTIFY) lParam;

Parameters
lppsn

A pointer to a PSHNOTIFY structure that contains information about the notification. This structure contains an NMHDR structure as its first member, hdr. The hwndFrom member of the NMHDR structure contains the handle to the property sheet. The lParam member of the PSHNOTIFY structure is a pointer to the message's MSG. It can be cast to an LPMSG type, to get access to the parameters of the message to be translated.

Return Value

Return PSNRET_MESSAGEHANDLED to indicate that no further processing is necessary. Return PSNRET_NOERROR to request normal processing.

Remarks

To set the return value, the dialog box procedure for the page must use the SetWindowLong function with the DWL_MSGRESULT value. The dialog box procedure must return TRUE.

Appendix K

PSN WIZBACK Notification

Notifies a page that the user has clicked the Back button in a wizard. This notification message is sent in the form of a WM_NOTIFY message.

Syntax

PSN_WIZBACK
lppsn = (LPPSHNOTIFY) lParam;

Parameters
lppsn

Pointer to a PSHNOTIFY structure that contains information about the notification. This structure contains an NMHDR structure as its first member, hdr. The hwndFrom member of this NMHDR structure contains the handle to the property sheet. The lParam member of the PSHNOTIFY structure does not contain any information.

Return Value

Return 0 to allow the wizard to go to the previous page. Return −1 to prevent the wizard from changing pages. To display a particular page, return its dialog resource identifier.

Remarks

To set the return value, the dialog box procedure for the page must call the SetWindowLong function with the DWL_MSGRESULT value and return TRUE. For example:

```
case PSN_WIZBACK :
    SetWindowLong(hDlg, DWL_MSGRESULT, 0);
    break;
case PSN_WIZNEXT :
...
```

Note The property sheet is in the process of manipulating the list of pages when the PSN_WIZBACK notification is sent. You can add, insert, or remove pages in response to these notifications, but special care must be taken if you insert or remove pages before the current page.

Appendix L

PSN WIZFINISH Notification

Notifies a page that the user has clicked the Finish button in a wizard. This notification message is sent in the form of a WM_NOTIFY message.

Syntax

PSN_WIZFINISH
lppsn = (LPPSHNOTIFY) lParam;

Parameters
lppsn

Pointer to a PSHNOTIFY structure that contains information about the notification. This structure contains an NMHDR structure as its first member, hdr. The hwndFrom member of this NMHDR structure contains the handle to the property sheet. The lParam member of the PSHNOTIFY structure does not contain any information.

Return Value

Return TRUE to prevent the wizard from finishing.

Return a window handle to prevent the wizard from finishing. The wizard will set the focus to that window. The window must be owned by the wizard page.

Return FALSE to allow the wizard to finish.

Remarks

To set the return value, the dialog box procedure for the page must use the SetWindowLong function with the DWL_MSGRESULT value, and the dialog box procedure must return TRUE.

If your application returns TRUE to prevent a wizard from finishing, it has no control over which window on the page receives focus. Applications that need to stop a wizard from finishing should normally do so by returning the handle of the window on the wizard page that is to receive focus.

Appendix M

PSN WIZNEXT Notification

Notifies a page that the user has clicked the Next button in a wizard. This notification message is sent in the form of a WM_NOTIFY message.

Syntax

PSN_WIZNEXT

lppsn=(LPPSHNOTIFY)lParam;

PSN_WIZNEXT
lppsn = (LPPSHNOTIFY) lParam;

Pointer to a PSHNOTIFY structure that contains information about the notification. This structure contains an NMHDR structure as its first member, hdr. The hwndFrom member of this NMHDR structure contains the handle to the property sheet. The lParam member of the PSHNOTIFY structure does not contain any information.

Return Value

Return 0 to allow the wizard to go to the next page. Return −1 to prevent the wizard from changing pages. To display a particular page, return its dialog resource identifier.

Remarks

To set the return value, the dialog box procedure for the page must call the SetWindowLong function with the DWL_MSGRESULT value and return TRUE. For example:

```
case PSN_WIZNEXT :
    SetWindowLong(hDlg, DWL_MSGRESULT, 0);
    break;
case PSN_WIZBACK :
...
```

Note: The property sheet is in the process of manipulating the list of pages when the PSN_WIZNEXT notification is sent. You can add, insert, or remove pages in response to these notifications, but special care must be taken if you insert or remove pages before the current page.

Appendix N

PSM ADDPAGE Message

Adds a new page to the end of an existing property sheet. You can send this message explicitly or by using the PropSheet_AddPage macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_ADDPAGE, | // message ID |
| (WPARAM) wParam, | // = 0; not used, must be zero |
| (LPARAM) lParam | // = (LPARAM) (HPROPSHEETPAGE) |
| | hpage; |
| ); | |

Parameters
wParam

Must be zero.

hpage

Handle to the page to add. The page must have been created by a previous call to the CreatePropertySheetPage function.

Return Value

Returns TRUE if successful, or FALSE otherwise.

Remarks

The new page should be no larger than the largest page currently in the property sheet because the property sheet is not resized to fit the new page.

A number of messages and one function call occur while the property sheet is manipulating the list of pages. While this action is taking place, attempting to modify the list of pages will have unpredictable results.

Accordingly, you should not use the PSM_ADDPAGE message in your implementation of PropSheetPageProc or while handling the following notifications and Microsoft® Windows® messages:
PSN_KILLACTIVE
PSN_RESET
PSN_SETACTIVE
WM_DESTROY
WM_INITDIALOG

If you need to modify a property sheet page while you are handling one of these messages or while PropSheetPageProc is in operation, post yourself a private Windows message. Your application will not receive that message until after the property sheet manager has finished its tasks. Then you can modify the list of pages.

Appendix O

PSM HWNDTOINDEX Message

Takes the window handle of the property sheet page and returns its zero-based index. You can send this message explicitly or use the PropSheet_HwndToIndex macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_HWNDTOINDEX, | // message ID |
| (WPARAM) wParam, | // = (WPARAM) (HWND) |
| | hPageDlg; |
| (LPARAM) lParam | // = 0; not used, must be zero |
| ); | |

Parameters

hPageDlg

Handle to the page's window.

lParam

Must be zero.

Return Value

Returns the zero-based index of the property sheet page specified by hPageDlg if successful. Otherwise, it returns −1.

Appendix P

PSM IDTOINDEX Message

Takes the resource identifier (ID) of a property sheet page and returns its zero-based index. You can send this message explicitly or use the PropSheet_IdToIndex macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_IDTOINDEX, | // message ID |
| (WPARAM) wParam, | // = 0; not used, must be zero |
| (LPARAM) lParam | // = (LPARAM) (int) iPageID; |
| ); | |

Parameters
wParam

Must be zero.

iPageID

Resource ID of the page.

Return Value

Returns the zero-based index of the property sheet page specified by iPageID if successful. Otherwise, it returns −1.

Appendix Q

PSM INDEXTOHWND Message

Takes the index of a property sheet page and returns its window handle. You can send this message explicitly or use the PropSheet_IndexToHwnd macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_INDEXTOHWND, | // message ID |
| (WPARAM) wParam, | // = (WPARAM) (int) iPageIndex; |
| (LPARAM) lParam | // = 0; not used, must be zero |
| ); | |

Parameters
iPageIndex

Zero-based index of the page.

lParam

Must be zero.

Return Value

Returns the handle to the window of the property sheet page specified by iPageIndex if successful. Otherwise, it returns zero.

Appendix R

PSM INDEXTOID Message

Takes the index of a property sheet page and returns its resource identifier (ID). You can send this message explicitly or use the PropSheet_IndexTold macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_INDEXTOID, | // message ID |
| (WPARAM) wParam, | // = (WPARAM) (int) iPageIndex; |
| (LPARAM) lParam | // = 0; not used, must be zero |
| ); | |

Parameters

iPageIndex

Zero-based index of the page.

lParam

Must be zero.

Return Value

Returns the resource ID of the property sheet page specified by iPageIndex if successful. Otherwise, it returns zero.

Appendix S

PSM INDEXTOPAGE Message

Takes the index of a property sheet page and returns its HPROPSHEETPAGE handle. You can send this message explicitly or use the PropSheet_IndexToPage macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_INDEXTOPAGE, | // message ID |
| (WPARAM) wParam, | // = (WPARAM) (int) iPageIndex; |
| (LPARAM) lParam | // = 0; not used, must be zero |
| ); | |

Parameters
iPageIndex

Zero-based index of the page.

lParam

Must be zero.

Return Value

Returns the HPROPSHEETPAGE handle of the property sheet page specified by iPageIndex if successful. Otherwise, it returns zero.

Appendix T

PSM PAGETOINDEX Message

Takes the HPROPSHEETPAGE handle of the property sheet page and returns its zero-based index. You can send this message explicitly or use the PropSheet_PageToIndex macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_PAGETOINDEX, | // message ID |
| (WPARAM) wParam, | // = (WPARAM) |
| | (HPROPSHEETPAGE) hPage; |
| (LPARAM) lParam | // = 0; not used, must be zero |
| ); | |

Parameters
hpage

HPROPSHEETPAGE handle to the property sheet page.

wParam

Must be zero.

Return Value

Returns the zero-based index of the property sheet page specified by hpage if successful. Otherwise, it returns −1.

Appendix U

PSM PRESSBUTTON Message

Simulates the selection of a property sheet button. You can send this message explicitly or by using the PropSheet_PressButton macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_PRESSBUTTON, | // message ID |
| (WPARAM) wParam, | // = (WPARAM) (int) iButton; |
| (LPARAM) lParam | // = 0; not used, must be zero |
| ); | |

Parameters
iButton

Index of the button to select. This parameter can be one of the following values:
PSBTN_BACK
Selects the Back button.
PSBTN_CANCEL
Selects the Cancel button.
PSBTN_FINISH
Selects the Finish button.
PSBTN_NEXT
Selects the Next button.
   lParam

Must be zero.

Return Value

No return value.

Appendix V

PSM QUERYSIBLINGS Message

Sent to a property sheet, which then forwards the message to each of its pages. You can send this message explicitly or by using the PropSheet_QuerySiblings macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_QUERYSIBLINGS, | // message ID |
| (WPARAM) wParam, | // = (WPARAM) (long) param1; |
| (LPARAM) lParam | // = (LPARAM) (long) param2; |
| ); | |

Parameters
param1

First application-defined parameter.

param2

Second application-defined parameter.

Return Value

Returns the nonzero value from a page in the property sheet, or zero if no page returns a nonzero value.

Remarks

If a page returns a nonzero value, the property sheet does not send the message to subsequent pages.

Appendix W

PSM SETCURSEL Message

Activates the specified page in a property sheet. You can send this message explicitly or by using the PropSheet_SetCurSel macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_SETCURSEL, | // message ID |
| (WPARAM) wParam, | // = (WPARAM) (int) index; |
| (LPARAM) lParam | // = (LPARAM) |
| | (HPROPSHEETPAGE) hpage; |
| ); | |

Parameters
index

The zero-based index of the page. An application can specify the index or the handle, or both. If both are specified, hpage takes precedence.

hpage

The handle to the page to activate. An application can specify the index or the handle, or both. If both are specified, hpage takes precedence.

Return Value

Returns TRUE if successful, or FALSE otherwise.

Remarks

The window that is losing the activation receives the PSN_KILLACTIVE notification message, and the window that is gaining the activation receives the PSN_SETACTIVE notification message.

Appendix X

PSM SETCURSELID Message

Activates the given page in a property sheet based on the resource identifier of the page. You can send this message explicitly or by using the PropSheet_SetCurSelByID macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_SETCURSELID, | // message ID |
| (WPARAM) wParam, | // = 0; not used, must be zero |
| (LPARAM) lParam | // = (LPARAM) (int) id; |
| ); | |

Parameters
wParam

Must be zero.

id

Resource identifier of the page to activate.

Return Value

Returns TRUE if successful, or FALSE otherwise.

Remarks

The window that is losing the activation receives the PSN_KILLACTIVE notification message, and the window that is gaining the activation receives the PSN_SETACTIVE notification message.

Appendix Y

PSM SETFINISHTEXT Message

Sets the text of the Finish button in a wizard, shows and enables the button, and hides the Next and Back buttons. You can send this message explicitly or by using the PropSheet_SetFinishText macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_SETFINISHTEXT, | // message ID |
| (WPARAM) wParam, | // = 0; not used, must be zero |
| (LPARAM) lParam | // = (LPARAM) (LPTSTR) |
| | lpszText; |
| ); | |

Parameters
wParam

Must be zero.

lpszText

Pointer to the new text for the Finish button.

Return Value

No return value.

Remarks

By default, the Finish button does not have a keyboard accelerator. You can create a keyboard accelerator with this message by including an ampersand (&) in the text string that you assign to lpszText. For example, “&Finish” defines F as the accelerator key.

Appendix Z

PSM SETHEADERTITLE Message

Sets the title text for the header of a wizard's interior page. You can send this message explicitly or use the PropSheet_SetHeaderTitle macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_SETHEADERTITLE, | // message ID |
| (WPARAM) wParam, | // = (WPARAM) (int) |
| | iPageIndex; |
| (LPARAM) lParam | // = (LPARAM) |
| | (LPCTSTR) pszHeaderTitle; |
| ); | |

Parameters
iPageIndex

Zero-based index of the wizard's page.

pszHeaderTitle

New header subtitle.

Return Value

No return value.

Remarks

If you specify the current page, it will immediately be repainted to display the new title.

Appendix AA

PSM SETNEXTTEXT Message

Sets the text of the Next button in a wizard. You can send this message explicitly or by using the PropSheet_SetNextText macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_SETNEXTTEXT, | // message ID |
| (WPARAM) wParam, | // = 0; not used, must be zero |
| (LPARAM) lParam | // = (LPARAM) (LPTSTR) lpszText; |
| ); | |

Parameters
wParam

Must be zero.

lpsztext

Pointer to the new text for the Next button.

Return Value

No return value.

Remarks

You can create a keyboard accelerator with this message by including an ampersand (&) in the text string that you assign to lpszText. For example, “&Next” defines N as the accelerator key.

Appendix BB

PSM SETWIZBUTTONS Message

Enables or disables the Back, Next, and Finish buttons in a wizard. You can also use the PropSheet_SetWizButtons macro to post the message.

Syntax

To send this message, call the SendMessage function as follows.

| | |
|---|---|
| lResult = SendMessage( | // returns LRESULT in lResult |
| (HWND) hWndControl, | // handle to 1destination control |
| (UINT) PSM_SETWIZBUTTONS, | // message ID |
| (WPARAM) wParam, | // = 0; not used, must be zero |
| (LPARAM) lParam | // = (LPARAM) (DWORD) |
| | dwFlags; |
| ); | |

Parameters
wParam

Must be zero.

dwFlags

Value that specifies which property sheet buttons are enabled. You can combine one or more of the following flags.
PSWIZB_BACK
Enables the Back button. If this flag is not set, the Back button is displayed as disabled.
PSWIZB_DISABLEDFINISH
Displays a disabled Finish button.
PSWIZB_FINISH
Displays an enabled Finish button.
PSWIZB_NEXT
Enables the Next button. If this flag is not set, the Next button is displayed as disabled.
   Return Value

No return value.

Remarks

If your notification handler uses PostMessage to send a PSM_SETWIZBUTTONS message, do nothing that will affect window focus until after the handler returns. For example, if you call MessageBox immediately after using PostMessage to send PSM_SETWIZBUTTONS, the message box will receive focus. Since posted messages are not delivered until they reach the head of the message queue, the PSM_SETWIZBUTTONS message will not be delivered until after the wizard has lost focus to the message box. As a result, the property sheet will not be able to properly set the focus for the buttons.

If you send the PSM_SETWIZBUTTONS message during your handling of the PSN_SETACTIVE notification message, use the PostMessage function rather than the SendMessage function. Otherwise, the system will not update the buttons properly. If you use the PropSheet_SetWizButtons macro to send this message, it will be posted. At any other time, you can use SendMessage to send PSM_SETWIZBUTTONS.

Wizards display either three or four buttons below each page. This message is used to specify which buttons are enabled. Wizards normally display Back, Cancel, and either a Next or Finish button. You typically enable only the Next button for the welcome page, Next and Back for interior pages, and Back and Finish for the completion page. The Cancel button is always enabled. Normally, setting PSWIZB_FINISH or PSWIZB_DISABLEDFINISH replaces the Next button with a Finish button. To display Next and Finish buttons simultaneously, set the PSH_WIZARDHASFINISH FLAG in the dwFlags member of the wizard's PROPSHEETHEADER structure when you create the wizard. Every page will then display all four buttons.

Appendix CC

PSM SHOWWIZBUTTONS Message

Show or hide the Back, Next, and Finish buttons in a wizard. You can also use the PropSheet_ShowWizButtons macro to post the message.

Syntax

To send this message, call the SendMessage function as follows.

| | |
|---|---|
| lResult = SendMessage( | // returns LRESULT in |
| | lResult |
| (HWND) hWndControl, | // handle to destination control |
| (UINT) PSM_SHOWWIZBUTTONS, | // message ID |
| (WPARAM) wParam, | // = (WPARAM)(DWORD) |
| | dwState; |
| (LPARAM) lParam | // = (LPARAM) (DWORD) |
| | dwMask; |
| ); | |

Parameters
wParam

State of the buttons that are specified in dwFlags. You can combine one or more of the flags specified in the dwFlags parameter.

dwFlags

Value that specifies which property sheet buttons are shown. You can combine one or more of the following flags.
PSWIZB_BACK
Show or hide the Back button.
PSWIZB_CANCEL
Show or hide the Cancel button.
PSWIZB_FINISH
Show or hide the Finish button.
PSWIZB_NEXT
Show or hide the Next button.
   Return Value

No return value.

Remarks

The following example will enable the Back button, and hide the Next button:
ShowWizButtons(PSWIZB_BACK/*state*/, PSWIZB_BACK|PSWIZB_NEXT/*mask*/)

If your notification handler uses PostMessage to send a PSM_SETWIZBUTTONS message, do nothing that will affect window focus until after the handler returns. For example, if you call MessageBox immediately after using PostMessage to send PSM_SETWIZBUTTONS, the message box will receive focus. Since posted messages are not delivered until they reach the head of the message queue, the PSM_SETWIZBUTTONS message will not be delivered until after the wizard has lost focus to the message box. As a result, the property sheet will not be able to properly set the focus for the buttons.

If you send the PSM_SETWIZBUTTONS message during your handling of the PSN_SETACTIVE notification message, use the PostMessage function rather than the SendMessage function. Otherwise, the system will not update the buttons properly. If you use the PropSheet_SetWizButtons macro to send this message, it will be posted. At any other time, you can use SendMessage to send PSM_SETWIZBUTTONS. Wizards display either three or four buttons below each page. This message is used to specify which buttons are enabled. Wizards normally display Back, Cancel, and either a Next or Finish button. You typically enable only the Next button for the welcome page, Next and Back for interior pages, and Back and Finish for the completion page. The Cancel button is always enabled. Normally, setting PSWIZB_FINISH or PSWIZB_DISABLEDFINISH replaces the Next button with a Finish button. To display Next and Finish buttons simultaneously, set the PSH_WIZARDHASFINISH FLAG in the dwFlags member of the wizard's PROPSHEETHEADER structure when you create the wizard. Every page will then display all four buttons.

Appendix DD

PROPSHEETHEADER Structure

Defines the frame and pages of a property sheet.

Syntax

```
typedef struct _PROPSHEETHEADER {
    DWORD dwSize;
    DWORD dwFlags;
    HWND hwndParent;
    HINSTANCE hInstance;
    union {
        HICON hIcon;
        LPCTSTR pszIcon;
        };
    LPCTSTR pszCaption;
    UINT nPages;
    UINT nStartPage;
    union {
        LPCPROPSHEETPAGE ppsp;
        HPROPSHEETPAGE *phpage;
        };
    PFNPROPSHEETCALLBACK pfnCallback;
#if (_WIN32_IE >= 0x0500)
    union {
        HBITMAP hbmHeader;
        LPCSTR pszbmHeader;
        };
#endif
} PROPSHEETHEADER, *LPPROPSHEETHEADER;
```

Members
dwSize

Size, in bytes, of this structure. The property sheet manager uses this member to determine which version of the PROPSHEETHEADER structure you are using. For more information, see the Remarks.

dwFlags

Flags that indicate which options to use when creating the property sheet page. This member can be a combination of the following values:
PSH_AEROWIZARD
Creates an AeroWizard-style property sheet. Required.
PSH_PROPSHEETPAGE
Uses the ppsp member and ignores the phpage member when creating the pages for the property sheet.
PSH_RTLREADING
Reverses the direction in which pszCaption is displayed. Normal windows display all text, including pszCaption, left-to-right (LTR). For languages such as Hebrew or Arabic that read right-to-left (RTL), a window can be mirrored and all text will be displayed RTL. If PSP_RTLREADING is set, pszCaption will instead read RTL in a normal parent window and LTR in a mirrored parent window.
PSH_RESIZABLE
Specifies that this wizard may be resized by the user. Maximize and minimize buttons will appear in the wizard's frame, and the frame will be sizable.
PSH_USECALLBACK
Calls the function specified by the pfnCallback member when initializing the property sheet defined by this structure.
PSH_USEHBMHEADER
If specified with the PSH_HEADERBITMAP flag, will obtain the header bitmap from the hbmHeader member instead of the pszbmHeader member.
PSH_HEADERBITMAP
Use the value pszbmHeader for the header bitmap (unless PSH_USEHBMHEADER is also specified)
PSH_LARGE
Specifies that a “large format” wizard should be created. A “large format” wizard is designed for larger displays.
PSH_USEHICON
Uses hlcon as the small icon in the title bar of the property sheet dialog box.
PSH_USEICONID
Uses pszlcon as the name of the icon resource to load and use as the small icon in the title bar of the property sheet dialog box.
PSH_USEPAGELANG
Specifies that the language for the property sheet will be taken from the first page's resource.
PSH_WIZARD
Creates a wizard property sheet. Required.
PSH_WIZARDHASFINISH
Always displays the Finish button on the wizard.
   hwndParent

Handle to the property sheet's owner window.

hInstance

Handle to the instance from which to load the icon or title string resource. If the pszIcon or pszCaption member identifies a resource to load, this member must be specified.

hIcon

Handle to the icon to use as the small icon in the title bar of the property sheet dialog box. If the dwFlags member does not include PSH_USEHICON, this member is ignored. This member is declared as a union with pszIcon.

pszIcon

Icon resource to use as the small icon in the title bar of the property sheet dialog box. This member can specify either the identifier of the icon resource or the address of the string that specifies the name of the icon resource. If the dwFlags member does not include PSH_USEICONID, this member is ignored. This member is declared as a union with hIcon.

pszCaption

Title of the property sheet dialog box. This member can specify either the identifier of a string resource or the address of a string that specifies the title.

nPages

Number of elements in the phpage array.

nStartPage

Zero-based index of the initial page that appears when the property sheet dialog box is created.

ppsp

Pointer to an array of PROPSHEETPAGE structures that define the pages in the property sheet. If the dwFlags member does not include PSH_PROPSHEETPAGE, this member is ignored. Note that the PROPSHEETPAGE structure is variable in size. Applications that parse the array pointed to by ppsp must take the size of each page into account. This member is declared as a union with phpage.

phpage

Pointer to an array of handles to the property sheet pages. Each handle must have been created by a previous call to the CreatePropertySheetPage function. If the dwFlags member includes PSH_PROPSHEETPAGE, phpage is ignored and should be set to NULL. When the PropertySheet function returns, any HPROPSHEETPAGE handles in the phpage array will have been destroyed. This member is declared as a union with ppsp.

pfnCallback

Pointer to an application-defined callback function that is called when the property sheet is initialized. For more information about the callback function, see the description of the PropSheetProc function. If the dwFlags member does not include PSH_USECALLBACK, this member is ignored.

hbmheader

Handle to the header bitmap. If the dwFlags member does not include PSH_USEHBMHEADER, this member is ignored.

pszbmHeader

Bitmap resource to use as the header. This member can specify either the identifier of the bitmap resource or the address of the string that specifies the name of the bitmap resource. If the dwFlags member includes PSH_USEHBMHEADER, this member is ignored.

Remarks

The dwSize field must be initialized, and set to sizeof(PROPSHEETHEADER).

Appendix EE

PROPSHEETPAGE Structure

This structure defines a page in a property sheet.

Syntax

```
typedef struct _PROPSHEETPAGE {
    DWORD dwSize;
    DWORD dwFlags;
    HINSTANCE hInstance;
    union {
        LPCSTR pszTemplate;
        LPCDLGTEMPLATE pResource;
        };
    DLGPROC pfnDlgProc;
    LPARAM lParam;
    LPFNPSPCALLBACK pfnCallback;
} PROPSHEETPAGE, *LPPROPSHEETPAGE;
```

Members
dwSize

Size, in bytes, of this structure. The property sheet manager uses this member to determine which version of the PROPSHEETHEADER structure you are using.

dwFlags

Flags that indicate which options to use when creating the property sheet page. This member can be a combination of the following values:
PSP_DLGINDIRECT
Creates the page from the dialog box template in memory pointed to by the pResource member. The PropertySheet function assumes that the template that is in memory is not write-protected. A read-only template will cause an exception in some versions of Microsoft® Windows®.
PSP_RTLREADING
Reverses the direction in which text is displayed.
PSP_USECALLBACK
Calls the function specified by the pfnCallback member when creating or destroying the property sheet page defined by this structure.
PSP_USEFUSIONCONTEXT
Use an activation context. To use an activation context, you must set this flag and assign the activation context handle to hActCtx. See the Remarks.
PSP_PREMATURE
Causes the page to be created when the property sheet is created. If this flag is not specified, the page will not be created until it is selected the first time.
PSP_COMMANDLINKS
Displays the page with command links; no footer region is included.
   hInstance

Handle to the instance from which to load an icon or string resource. If the pszHeaderTitle member identifies a resource to load, hInstance must be specified.

pszTemplate

Dialog box template to use to create the page. This member can specify either the resource identifier of the template or the address of a string that specifies the name of the template. If the PSP_DLGINDIRECT flag in the dwFlags member is set, psztemplate is ignored. This member is declared as a union with pResource.

pResource

Pointer to a dialog box template in memory. The PropertySheet function assumes that the template is not write-protected. A read-only template will cause an exception in some versions of Windows. To use this member, you must set the PSP_DLGINDIRECT flag in the dwFlags member. This member is declared as a union with pszTemplate.

pfnDlgProc

Pointer to the dialog box procedure for the page. Because the pages are created as modeless dialog boxes, the dialog box procedure must not call the EndDialog function.

lParam

When the page is created, a copy of the page's PROPSHEETPAGE structure is passed to the dialog box procedure with a WM_INITDIALOG message. The IParam member is provided to allow you to pass application-specific information to the dialog box procedure. It has no effect on the page itself. For more information, see Property Sheet Creation.

pfnCallback

Pointer to an application-defined callback function that is called when the page is created and when it is about to be destroyed. For more information about the callback function, see PropSheetPageProc. To use this member, you must set the PSP_USECALLBACK flag in the dwFlags member.

pszHeaderTitle

Title of the header area.

hActCtx

An activation context handle. Set this member to the handle that is returned when you create the activation context with CreateActCtx. The system will activate this context before creating the dialog box. You do not need to use this member if you use a global manifest. See the Remarks.

Remarks

The dwSize field must be initialized, and set to sizeof(PROPSHEETPAGE).

Appendix FF

PSHNOTIFY Structure

Contains information for the property sheet notification messages.

Syntax

```
typedef struct _PSHNOTIFY {
    NMHDR hdr;
    LPARAM lParam;
} PSHNOTIFY, *LPPSHNOTIFY;
```

Members
hdr

Address of an NMHDR structure that contains additional information about the notification.

lParam

Additional information about this notification. To determine what, if any, information is contained in this member, see the description of the particular notification message.

Appendix GG

PSM SETTITLE Message

Sets the title of a wizard. You can send this message explicitly or by using the PropSheet SetTitle macro.

Syntax

To send this message, call the SendMessage function as follows.

| | |
|---|---|
| lResult = SendMessage( | // returns LRESULT in lResult |
| (HWND) hWndControl, | // handle to destination control |
| (UINT) PSM_SETTITLE, | // message ID |
| (WPARAM) wParam, | // not used |
| (LPARAM) lParam | // = (LPARAM) (LPCWSTR) lpszText; |
| ); | |

Parameters
lpszText

Pointer to a buffer that contains the title string. If the high-order word of this parameter is NULL, the property sheet loads the string resource specified in the low-order word. If this parameter is NULL, the original title of the wizard will be restored.

Return Value

No return value.

1. A method of creating a dialog user interface, comprising:
(a) receiving from a first computer program a request to generate at least one dialog user interface, wherein
(i) the dialog user interface has a format defined by a second computer program,
(ii) the format includes a frame for containing multiple related dialogs, each of the related dialogs within the frame including predefined header and content regions, the format permitting text within the header regions and text and multiple types of user interface controls in the content regions,
(iii) the request includes data indicative of content to be placed within the content region of the at least one requested dialog, the content including at least one of text and a user interface control,
(iv) the request further includes data indicative of a main instruction, to be placed within the header region of the at least one requested dialog, advising a user how to respond to the content indicated by the content data, and
(v) the data of (iii) and (iv) are respectively received through programming interface portions corresponding to the content and header regions; and
(b) generating the at least one requested dialog in the second program in response to the request of step (a).

2. The method of claim 1, wherein:
step (a) comprises receiving a request from the first computer program to generate multiple dialog user interfaces to be displayed within the frame,
the request includes data indicative of multiple first type data structures respectively corresponding to the requested dialogs, and
each of the multiple first type data structures includes
data indicative of content to be placed within the content region of the corresponding dialog, said content including at least one of text and a user interface control, and
data indicative of a main instruction, to be placed within the header region of the corresponding dialog, advising a user how to respond to the content within the content region of the corresponding dialog.

3. The method of claim 2, wherein the request of step (a) includes data indicative of a second type data structure having data indicative of the multiple first type data structures.

4. The method of step 2, further comprising:
(c) sending a message from the second program indicating a user has completed a first of the multiple dialogs;
(d) receiving a message from the first program indicative of whether a second of the multiple dialogs should be displayed; and
(e) one of displaying or not displaying the second dialog based on the message of step (d).

5. The method of claim 1, wherein:
the dialog user interface format defined by the second computer program includes a predefined footer region, and
the footer region includes at least one default user interface control.

6. The method of claim 5, further comprising:
(c) receiving from a first computer program data indicative of text with which to re-label the at least one default user interface control of the footer region.

7. The method of claim 5, further comprising:
(c) receiving from a first computer program data indicating the at least one default user interface control of the footer region should not be displayed in the requested dialog.

8. The method of claim 1, wherein:
the request of step (a) further comprises data indicative of an icon to be placed within the header region of the at least one requested dialog, and
step (b) further comprises generating the at least one requested dialog to include the indicated icon.

9. The method of claim 1, wherein:
the request of step (a) further comprises data indicative of a background image to be applied to the header region of the at least one requested dialog, and
step (b) further comprises generating the at least one requested dialog to include the indicated background image.

10. A software architecture for creating dialog user interfaces, comprising:
at least one component configured to generate on a computer display a dialog user interface having a format defined by the at least one component, the format including a frame for containing multiple dialogs, each dialog within said frame including predefined header and content regions; and
at least one application program interface to access the at least one component, the at least one application program interface configured
to accept first data indicative of content to be placed within the content region of at least one requested dialog, such content including at least one of text and a user interface control, and
to accept second data indicative of a main instruction, to be placed within the header region of the at least one requested dialog, advising a user how to respond to the content displayed in the content region of the at least one requested dialog.

11. A computer-readable medium having stored thereon data representing sequences of instructions which, when executed by a processor, cause the processor to perform steps of a method for creating a dialog user interface, said steps comprising:
(a) receiving from a first computer program a request to generate at least one dialog user interface, wherein
(i) the dialog user interface has a format defined by a second computer program,
(ii) the format includes a frame for containing multiple related dialogs, each of the related dialogs within the frame including predefined header and content regions, the format permitting text within the header regions and text and multiple types of user interface controls in the content regions,
(iii) the request includes data indicative of content to be placed within the content region of the at least one requested dialog, the content including at least one of text and a user interface control,
(iv) the request further includes data indicative of a main instruction, to be placed within the header region of the at least one requested dialog, advising a user how to respond to the content indicated by the content data, and
(v) the data of (iii) and (iv) are respectively received through programming interface portions corresponding to the content and header regions; and
(b) generating the at least one requested dialog in the second program in response to the request of step (a).

12. The computer-readable medium of claim 11, wherein:
step (a) comprises receiving a request from the first computer program to generate multiple dialog user interfaces to be displayed within the frame,
the request includes data indicative of multiple first type data structures respectively corresponding to the requested dialogs, and
each of the multiple first type data structures includes
data indicative of content to be placed within the content region of the corresponding dialog, said content including at least one of text and a user interface control, and
data indicative of a main instruction, to be placed within the header region of the corresponding dialog, advising a user how to respond to the content within the content region of the corresponding dialog.

13. The computer-readable medium of claim 12, wherein the request of step (a) includes data indicative of a second type data structure having data indicative of the multiple first type data structures.

14. The computer-readable medium of step 12, comprising further instructions for performing the steps of:
(c) sending a message from the second program indicating a user has completed a first of the multiple dialogs;
(d) receiving a message from the first program indicative of whether a second of the multiple dialogs should be displayed; and
(e) one of displaying or not displaying the second dialog based on the message of step (d).

15. The computer-readable medium of claim 11, wherein:
the dialog user interface format defined by the second computer program includes a predefined footer region, and
the footer region includes at least one default user interface control.

16. The computer-readable medium of claim 15, comprising further instructions for performing the step of:
(c) receiving from a first computer program data indicative of text with which to re-label the at least one default user interface control of the footer region.

17. The computer-readable medium of claim 15, comprising further instructions for performing the step of:
(c) receiving from a first computer program data indicating the at least one default user interface control of the footer region should not be displayed in the requested dialog.

18. The computer-readable medium of claim 11, wherein:
the request of step (a) further comprises data indicative of an icon to be placed within the header region of the at least one requested dialog, and
step (b) further comprises generating the at least one requested dialog to include the indicated icon.

19. The computer-readable medium of claim 11, wherein:
the request of step (a) further comprises data indicative of a background image to be applied to the header region of the at least one requested dialog, and
step (b) further comprises generating the at least one requested dialog to include the indicated background image.

20. The computer-readable medium of claim 11, wherein:
step (b) further comprises generating the at least one requested dialog such that the frame includes a frame title distinct from the main instruction.
